(19) United States
(12) Patent Application Publication
(10) Pub. No.: US 2026/0065030 A1
(43) Pub. Date: Mar. 5, 2026

(54) METHODS AND DEVICES INCLUDING A GENERATIVE ARTIFICIAL INTELLIGENCE

(71) Applicant: Intel Corporation, Santa Clara, CA (US)

(72) Inventors: Arvind MERWADAY, Beaverton, OR (US); Shu-Ping YEH, San Jose, CA (US); Rath VANNITHAMBY, Portland, OR (US); Vallabhajosyula SOMAYAZULU, Portland, OR (US); Shilpa TALWAR, Cupertino, CA (US); Thushara HEWAVITHANA, Tempe, AZ (US); Fatemeh HAMIDI-SEPEHR, San Jose, CA (US)

(21) Appl. No.: 18/818,663

(22) Filed: Aug. 29, 2024

(51) Int. Cl. G06N 3/0475; G06N 3/045; G06N 3/0985

(52) U.S. Cl. CPC G06N 3/0475; G06N 3/045; G06N 3/0985

(57) ABSTRACT

An apparatus including an interface configured to receive first sensor data representative of a monitoring of an environment according to a first modality and second sensor data representative of a monitoring of the environment according to a second modality; and a processor configured to provide the first sensor data to an input of a first trained generative model configured to generate first output data comprising a first extracted feature of the first sensor data in a latent space; provide the second sensor data to an input of a second trained generative model configured to generate second output data comprising a second extracted feature of the second sensor data in the latent space; and combine the first output data and the second output data to generate a combined feature.

### TECHNICAL FIELD

Various aspects relate to methods and devices including a generative artificial intelligence.

### BACKGROUND

Communication and sensing have become integral parts of many futuristic use-cases and applications such as industrial robotics and automation, intelligent transportation systems, automated warehouses, etc. Deployment of multi-modal sensors such as depth camera, Radar, Lidar, etc., can provide information about the surrounding environment, and the wireless networks enable the sensors to share the sensing data with compute resources for precise perception of environment, decision-making, and taking actions in real time.

Scheduling communications in an wireless network by an access node of the wireless network may be considered as one of the fundamental challenges. Wireless nodes may need to coordinate their transmissions to avoid collisions and interference, while efficiently utilizing the limited channel resources. Various scheduling algorithms may be used to allocate time slots or transmission opportunities to nodes, with the goals of maximizing throughput, minimizing delay, ensuring fairness, and accommodating quality of service requirements.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows an example of a radio communication network.

FIG. 2 shows an example of a communication device.

FIG. 3 shows an example of a topology.

FIG. 4 shows an example of a topology.

FIG. 5 shows an exemplary device.

FIG. 6 shows an exemplary device.

FIG. 7 shows an exemplary environment and an exemplary device.

FIG. 8 shows an example of a training scheme.

FIG. 9 shows an exemplary device.

FIG. 10 shows an example of a block diagram.

FIG. 11 shows an example of a loop-based diagram.

FIG. 12 shows an exemplary device.

FIG. 13 shows an example of an attention architecture.

FIG. 14 shows an exemplary method.

FIG. 15 shows an exemplary method.

FIG. 16. shows an example of a processor.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

The term “data fusion” may refer to or include combining data from multiple sources (e.g. multiple sensors) providing structured, semi-structured or unstructured data in order to form a more comprehensive data set. Such “data fusion” may be implemented to combine raw data, or data at a higher level, to make a decision, etc.

The term “feature fusion” may refer to or include combining features or attributes derived from different sources (e.g. data source, a AI model, etc.). In that sense, “feature fusion” may deal with gathering and/or merging informative characteristics of a given data, rather than the raw data itself. In certain parts of the disclosure “data fusion” may be used interchangeably with “feature fusion” where “data fusion” does not refer to fusion of raw data.

Moreover, the term “feature fusion” and “data fusion” may especially include a combination that indicates more information than the individual items (i.e. items being data or fusion) by dealing with the association and correlation between the individual items and exploiting the synergy in individual items.

The term “modality” may refer to or include a particular type of data or a particular mode of the expression of the data. In such a sense, the “modality” may be the type of a data perceived and interpreted by a system. An image may be considered to have a modality different from the modality represented by a sound. Therefore, “modality” should be understood as a characteristic of a feature and/or certain attributes of a feature.

The term “multi-modal” may refer to or include different modalities represented by different characteristics of different features potentially derived and/or extracted from different sources. Exemplarily, different types of sensors may provide different features and therefore different modalities. Such different modalities may be attempted to be merged (e.g. by way of feature fusion) within an environment or framework which effectively makes that environment/framework “multi-modal”.

The term “early fusion” within the context of data and/or feature fusion may refer to or include a technique involving a combination of data (e.g. raw data) represented as multi-modal prior to high-level processing and/or decision making. Therefore, data/feature subject to “early fusion” may be used as input to a e.g. machine learning model.

The term “late fusion” within the context of data and/or feature fusion may refer to or include a technique involving the processing of data pertaining to a specific modality. Exemplarily, the processing of data from a specific sensor from a plurality of sensors to generate independent predictions. Such predictions may be combined at a later stage to enable decision-making.

The term “cooperative sensing” may refer to a sensing/monitoring of an environment performed by a plurality of sensors within the environment. Such sensors may be distributed across the environment in order to present sensing data from different perspectives (e.g. different field-of-view) or modalities. “Cooperative sensing” may further include or require transmission of sensor data associated with the sensors deployed within the environment.

The term “multidimensional vector space” may refer to or include a construct in which the vectors contain a plurality of components, each of the plurality of components is associated with a dimension (e.g. three-dimensional vector space, n-dimensional vector space, etc.).

The term “high dimensional space” may refer to or include a vector space with a relatively large number of dimensions (e.g. five-dimensional space, six-dimensional space, n-dimensional space, etc.). Accordingly, “low dimensional space” may refer to or include a vector space with a relatively small number of dimensions (e.g. two-dimensional space). In that sense, “low dimensional space” may be simplistic compared to “high dimensional space” in terms of tractability (e.g. visualization).

The term “latent space” may refer to or include an interpretation of a high-dimensional data in order to represent the discriminative features of the high-dimensional data in a low-dimensional space. Such low-dimensional space may be the “latent space” (i.e. low-dimensional latent space). A discriminative feature may include e.g. a feature vector associated with the high-dimensional data.

The apparatuses and methods of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-TDD”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHZ, 3.4-3.6 GHZ, 3.6-3.8 GHz and further frequencies and SAS=Spectrum Access System in 3.55-3.7 GHZ and further frequencies), and may use various spectrum bands including, but not limited to, IMT (International Mobile Telecommunications) spectrum (including 450-470 MHz, 790 960 MHz, 1710 2025 MHz, 2110-2200 MHz, 2300-2400 MHz, 2500-2690 MHz, 698 790 MHz, 610 790 MHz, 3400 3600 MHz, etc., where some bands may be limited to specific region(s) and/or countries), IMT advanced spectrum, IMT-2020 spectrum (expected to include 3600 3800 MHz, 3.5 GHz bands, 700 MHz bands, bands within the 24.25 86 GHz range, etc.), spectrum made available under FCC's “Spectrum Frontier” 5G initiative (including 27.5-28.35 GHZ, 29.1-29.25 GHZ, 31-31.3 GHZ, 37-38.6 GHz, 38.6-40 GHz, 42-42.5 GHZ, 57-64 GHZ, 64-71 GHZ, 71-76 GHZ, 81-86 GHz and 92-94 GHz, etc.), the ITS (Intelligent Transport Systems) band of 5.9 GHZ (typically 5.85 5.925 GHZ) and 63 64 GHZ, bands currently allocated to WiGig such as WiGig Band 1 (57.24 59.40 GHZ), WiGig Band 2 (59.40 61.56 GHZ) and WiGig Band 3 (61.56 63.72 GHZ) and WiGig Band 4 (63.72 65.88 GHZ), the 70.2 GHZ-71 GHz band, any band between 65.88 GHz and 71 GHZ, bands currently allocated to automotive radar applications such as 76 81 GHZ, and future bands including 94 300 GHz and above. Furthermore, the apparatuses and methods described herein can also employ radio communication technologies on a secondary basis on bands such as the TV White Space bands (typically below 790 MHz) where e.g. the 400 MHz and 700 MHz bands are prospective candidates. Besides cellular applications, specific applications for vertical markets may be addressed such as PMSE (Program Making and Special Events), medical, health, surgery, automotive, low-latency, drones, etc. applications. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier 1 users, followed by tier 2, then tier 3, etc. users, etc. The apparatuses and methods described herein can also use radio communication technologies with different Single Carrier or OFDM flavors (CP OFDM, SC FDMA, SC OFDM, filter bank-based multicarrier (FBMC), OFDMA, etc.) and e.g. 3GPP NR (New Radio), which can include allocating the OFDM carrier data bit vectors to the corresponding symbol resources.

For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Arca radio communication technologies may be generally referred to herein as “cellular” communication technologies.

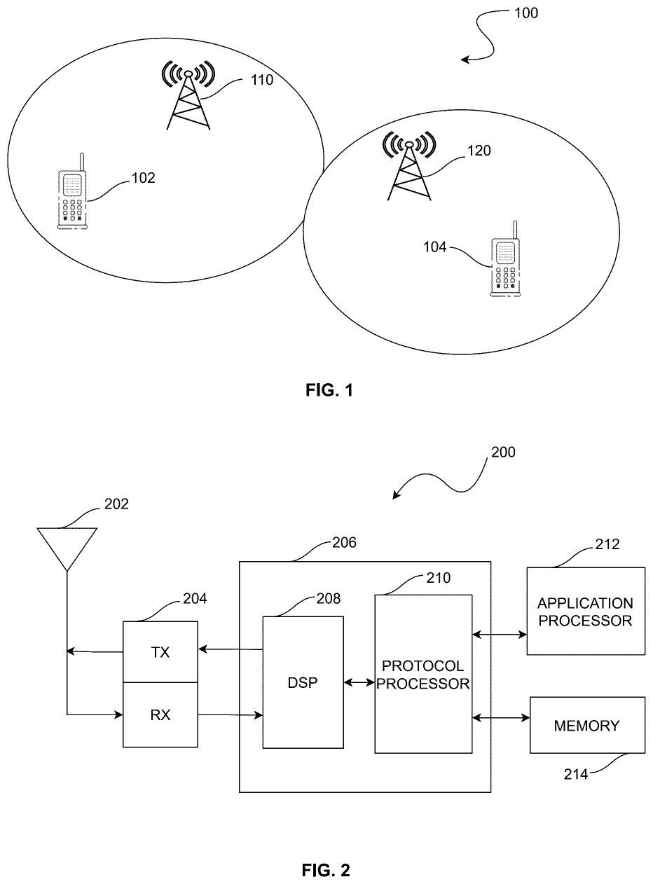

FIGS. 1 and 2 depict a general network and device architecture for wireless communications, including in particular aspects of a mobile communication network. In particular, FIG. 1 shows exemplary radio communication network 100 according to some aspects, which may include terminal devices 102 and 104 and network access nodes 110 and 120. Radio communication network 100 may communicate with terminal devices 102 and 104 via network access nodes 110 and 120 over a radio access network. Although certain examples described herein may refer to a particular radio access network context (e.g., LTE, UMTS, GSM, other 3rd Generation Partnership Project (3GPP) networks, WLAN/WiFi, Bluetooth, 5G NR, mmWave, etc.), these examples are demonstrative and may therefore be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., eNodeBs, NodeBs, Base Transceiver Stations (BTSs), gNodeBs, or any other type of base station), while terminal devices 102 and 104 may be cellular terminal devices (e.g., Mobile Stations (MSs), User Equipments (UEs), or any type of cellular terminal device). Network access nodes 110 and 120 may therefore interface (e.g., via backhaul interfaces) with a cellular core network such as an Evolved Packet Core (EPC, for LTE), Core Network (CN, for UMTS), or other cellular core networks, which may also be considered part of radio communication network 100. The cellular core network may interface with one or more external data networks. In an exemplary short-range context, network access node 110 and 120 may be access points (APs, e.g., WLAN or WiFi APs), while terminal device 102 and 104 may be short range terminal devices (e.g., stations (STAs)). Network access nodes 110 and 120 may interface (e.g., via an internal or external router) with one or more external data networks. Network access nodes 110 and 120 and terminal devices 102 and 104 may include one or multiple transmission/reception points (TRPs).

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

The radio access network and core network (if applicable, such as for a cellular context) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include LTE, UMTS, GSM, WiMAX, Bluetooth, WiFi, mmWave, etc., any of which may be applicable to radio communication network 100.

FIG. 2 shows an exemplary internal configuration of a communication device according to various aspects provided in this disclosure. The communication device may include a terminal device 102, and it will be referred to as communication device 200, but the communication device may also include various aspects of network access nodes 110, 120 as well. In some examples, the communication device 200 may be a further entity within the radio communication network 100, which may communicate with multiple network access nodes 110, 120. The communication device 200 may include antenna system 202, radio frequency (RF) transceiver 204, baseband modem 206 (including digital signal processor 208 and protocol controller 210), application processor 212, and memory 214. Although not explicitly shown in FIG. 2, in some aspects communication device 200 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Communication device 200 may transmit and receive radio signals on one or more radio access networks. Baseband modem 206 may direct such communication functionality of communication device 200 according to the communication protocols associated with each radio access network, and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness, the configuration of communication device 200 shown in FIG. 2 depicts only a single instance of such components.

Communication device 200 may transmit and receive wireless signals with antenna system 202. Antenna system 202 may be a single antenna or may include one or more antenna arrays that each include multiple antenna elements. For example, antenna system 202 may include an antenna array at the top of communication device 200 and a second antenna array at the bottom of communication device 200. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., In-Phase/Quadrature (IQ) samples) to provide to baseband modem 206. RF transceiver 204 may include analog and digital reception components including amplifiers (e.g., Low Noise Amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., Power Amplifiers (PAs), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204, including specifying the transmit and receive radio frequencies for operation of RF transceiver 204. In some examples, the ADCs may be or may include an ADC circuit as described herein.

In some examples, communication device 200 may include a communication circuit. Communication device 200 may transmit and receive communication signals with the communication circuit. The communication circuit may be couplable to specified communication interfaces (e.g. E2, A1, O1, etc.). In some aspects, such communication interfaces may be implemented by wireless or wired connections (e.g. backhaul, etc.). In particular, the communication circuit may transmit and receive communication signals to/from network access nodes 110, 120, or an intermediate entity within the radio communication network 100 that may communicate with network access nodes 110, 120. The communication circuit may include RF transceiver 204, and in such an example, the RF transceiver 204 may be configured to transmit and receive communication signals via the respective communication interface.

As shown in FIG. 2, baseband modem 206 may include digital signal processor 208, which may perform physical layer (PHY, Layer 1) transmission and reception processing to, in the transmit path, prepare outgoing transmit data provided by protocol controller 210 for transmission via RF transceiver 204, and, in the receive path, prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., ASICs, FPGAs, and other hardware) that are digitally configured to specific execute processing functions, where the one or more processors of digital signal processor 208 may offload certain processing tasks to these dedicated hardware circuits, which are known as hardware accelerators.

Communication device 200 may be configured to operate according to one or more radio communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the radio communication components of communication device 200 (antenna system 202, RF transceiver 204, and digital signal processor 208) in accordance with the communication protocols of each supported radio communication technology, and accordingly may represent the Access Stratum and Non-Access Stratum (NAS) (also encompassing Layer 2 and Layer 3) of each supported radio communication technology. Protocol controller 210 may be structurally embodied as a protocol processor configured to execute protocol stack software (retrieved from a controller memory) and subsequently control the radio communication components of communication device 200 to transmit and receive communication signals in accordance with the corresponding protocol stack control logic defined in the protocol software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to facilitate the transfer of application layer data to and from radio communication device 200 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Communication device 200 may also include application processor 212 and memory 214. Application processor 212 may be a CPU, and may be configured to handle the layers above the protocol stack, including the transport and application layers. Application processor 212 may be configured to execute various applications and/or programs of communication device 200 at an application layer of communication device 200, such as an operating system (OS), a user interface (UI) for supporting user interaction with communication device 200, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of communication device 200, such as a hard drive or another such permanent memory device. Although not explicitly depicted in FIG. 2, the various other components of communication device 200 shown in FIG. 2 may additionally each include integrated permanent and non-permanent memory components, such as for storing software program code, buffering data, etc.

Application processor 212 may be configured to implement various operations provided herein, in particular with respect to the implementation of one or more AI/MLs that are used for RRM of multiple cells associated with multiple network access nodes (e.g. network access node 110, 120) serving to multiple terminal devices (e.g. terminal devices 102, 104). In some examples, application processor 212 may control an external processor that is configured to implement the one or more AI/MLs. In some aspects, the external processor may be particularly suitable for implementing AI/MLs, such as GPUs, neuromorphic chips or circuits, parallel processors, etc.

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select available network access nodes in order to maintain a strong radio access connection with the radio access network of radio communication network 100. For example, communication device 200 may establish a radio access connection with network access node 110 while terminal device 104 may establish a radio access connection with network access node 112. In the event that the current radio access connection degrades, terminal devices 102 or 104 may seek a new radio access connection with another network access node of radio communication network 100; for example, terminal device 104 may move from the coverage area of network access node 112 into the coverage area of network access node 110. As a result, the radio access connection with network access node 112 may degrade, which terminal device 104 may detect via radio measurements such as signal strength or signal quality measurements of network access node 112. Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network protocols and may be employed by terminal devices and the radio access network in order to maintain strong radio access connections between each terminal device and the radio access network across any number of different radio access network scenarios.

In some examples described herein, a communication system and a sensing system may be deployed within a unified framework to form a joint communication and sensing system (JCAS). Such a technology may refer to or include a combination of wireless communication and sensing capabilities. A JCAS may enable the efficient use of wireless resources as well as realize sensing of a network environment. In some examples, a communication or a sensing operation described herein may include automotive, surveillance, industrial automation, automated moving robots (AMR), drone operations, etc.

Even though JCAS systems have prevailed together in several use-cases, typically communication system and sensing system are designed and developed in a separate manner. Therefore, the level of integration between these two systems (i.e. communication system and sensing system) have been limited. Recent breakthroughs achieved within the technical field of generative artificial intelligence (AI) technology have inspired the research community to address some of the complex and challenging issues with respect to the communication and/or sensing operations described herein.

The term “generative AI” as used herein may refer to and/or include technologies like transformer-based models, large language models (LLM), autoregressive models, diffusion models, and so on. A generative AI may include an AI (e.g. trained machine learning model) that is configured to generate a new content, such as parameters, text, images, audio, video based on the patterns and characteristics learned from training data.

In accordance with various aspects of the disclosure, the issues that need to be addressed may include providing an efficient and scalable method for multi-modal feature fusion. The accuracy and reliability of algorithms used for environment perception may benefit from fusion of sensing data from multi-modal sensors deployed in an environment. In this regards, multi-modal sensors may refer to or include different type of deployed sensors delivering data with modalities different from one another. Exemplarily, a camera deployed within the environment may provide a modality associated with the type of sensor data provided by the camera, while a Lidar may provide another modality associated with the type of sensor data provided by the Lidar. Nevertheless, providing a scalable and efficient method for fusion of sensing data from arbitrarily deployed sensors within an environment network environment may be desirable. The term “environment” may be used herein to refer to designated boundaries, settings, and/or context that is subject to the associated monitoring. Illustratively, the environment may include a wireless communication environment for communication operations and/or an environment in designated spatial boundaries (e.g. a factory, a warehouse). Such deployed sensors may be fixed sensors and/or mobile sensors with different modalities as exemplified.

Some aspects described herein regarding communication and/or sensing systems may include a generative AI-based base station scheduler. A base station scheduler may be a configured for efficiently allocating and managing network resources among user equipments (i.e. communication devices). Therefore, a base station scheduler may be configured for optimizing network efficiency of a radio communication network, such as the radio communication network 100.

A base station may refer to a main communication point for one or more wireless communication devices, such as the communication device 200. Therefore, the communication device may also be attributed to one of the terminal devices shown in FIG. 1, namely terminal device 102 or terminal device 104, while the base station may exemplarily refer to one of the network access nodes shown in FIG. 1, namely network access node 110, or network access node 120. Although FIG. 1 depicts that each communication device (e.g. terminal device 102) is connected to a different base station (e.g. network access node 110), the skilled person would immediately recognize that it is possible to realize a communication network (e.g. radio communication network 100) in which a base station (e.g. network access node 110) serves a plurality of communication devices (e.g. terminal device 102, terminal device 104, etc.). That is, the same base station may serve multiple users.

A base station scheduler may utilize a large number of input parameters for decision-making. Such input parameters may include user-level parameters encompassing channel state information (CSI), user traffic per application flow, buffer status report (BSR), quality of service (QoS) requirements, priority level, user mobility, user location, etc. The input parameters may also include network-level parameters such as network congestion, interference, network load, and so on. The base station scheduler may aim to enhance overall network performance, improve user experience, and optimize usage of available network resources by efficiently managing the input parameters.

A base station may generate decisions based on the input parameters. Such decisions may refer to or include user selection, time resources allocation, slot allocation, frequency resources allocation, physical resource block (PRB) allocation, space resources/multi-input multi-output (MIMO)/antenna configurations, joint transmit (Tx)/receive (Rx) with multiple distributed units (DUs), Tx power, etc. Hence, the base station may have to make complex decisions to jointly optimize user key performance indexes (KPIs) including latency, throughput, jitter, packet error rate, etc. and network KPIs including resource utilization, capacity, coverage/cell-edge throughput, network congestion, interference, energy efficiency, etc. However, conventional techniques embraced by current solutions are not optimal because of large dimensionality of the optimization space.

Some aspects described herein may include providing a mutual coordination between sensing and communication. Currently, a communication system and a sensing system may not coordinate with each other to leverage mutual performance benefits. The sensing data associated with the sensing system may contain information about the surrounding environment, which may be useful for the communication system for performance optimization. Communication data associated with the communication system, on the other hand, may provide certain information, which may be useful for the sensing system to improve the sensing performance. However, the absence of a systematic framework available to realize such coordination between sensing and communication (i.e. sensing and communication systems) may prevent exploiting mutual performance benefits.

Various aspects of the disclosure relate to methods and devices based on generative AI to address the exemplified issues. From a conventional perspective, cooperative sensing may be performed via late fusion of sensor data from different nodes (e.g. different sensors). By contrast, there are recent researches suggesting the use of early fusion to provide significant performance improvements in cooperative sensing. However, early fusion may require transmission of raw sensor data, which may be considered as a challenging task in time-sensitive wireless communications due to the required volume of raw sensor data conflicting with stringent latency requirements in that time-sensitive wireless communications scheme. A potential solution may be through feature fusion in order to overcome such limitations as the feature fusion does not require transmission of raw sensor data, and despite this, provides performance improvement over late fusion.

There are several use cases that require cooperative sensing for efficient and reliable operation of a system. Some examples include industrial robotics, intelligent transportation systems, automated warehouses, etc. In these use cases, sensing data from multiple sensors need to be combined to set forth cooperative sensing (e.g. of an environment) in order to improve reliability of the of environment perception. Such multiple sensors may include different sensor types and different field-of-view. Furthermore, different sensor types may be associated with different types of sensor data, and hence, different modalities.

As denoted, leveraging early fusion may provide significant performance improvements in cooperative sensing. Nevertheless, early fusion requires transmission of raw sensor data over wireless medium such as cellular network, or Wi-Fi. Transmission of raw sensor data is challenging in time-critical applications due to limited network capacity and stringent latency requirements. On the other hand, using late fusion may not require large communication resources as the early fusion does. But, on the flip side, using late fusion may degrade cooperative sensing performance. Thus, transmitting the features of environment, rather than raw sensor data, may be a promising direction to overcome the challenges of limited spectrum resources, while maintaining close-to-optimum performance of cooperative sensing.

In some aspects, fusion of multi-modal features may not be a straightforward task as different types of sensors generate data in different domains, and therefore need different AI models for data processing. For example, a camera may generate image data, while a Lidar may generate point-cloud data. As the data generated by different sensors (e.g. camera vs. Lidar) have different modalities, features extracted from them may require different AI models for processing. Although there are proposed methods that accept features from different domains (e.g. different modalities) and perform feature fusion, such methods have certain constraints such as sensor placement, sensor alignment, etc. and therefore cannot be efficiently scaleup to combine features from different sensor nodes having different field-of-view. Various aspects of the disclosure relate to methods and devices based on generative AI to address the exemplified issues and overcome such limitations.

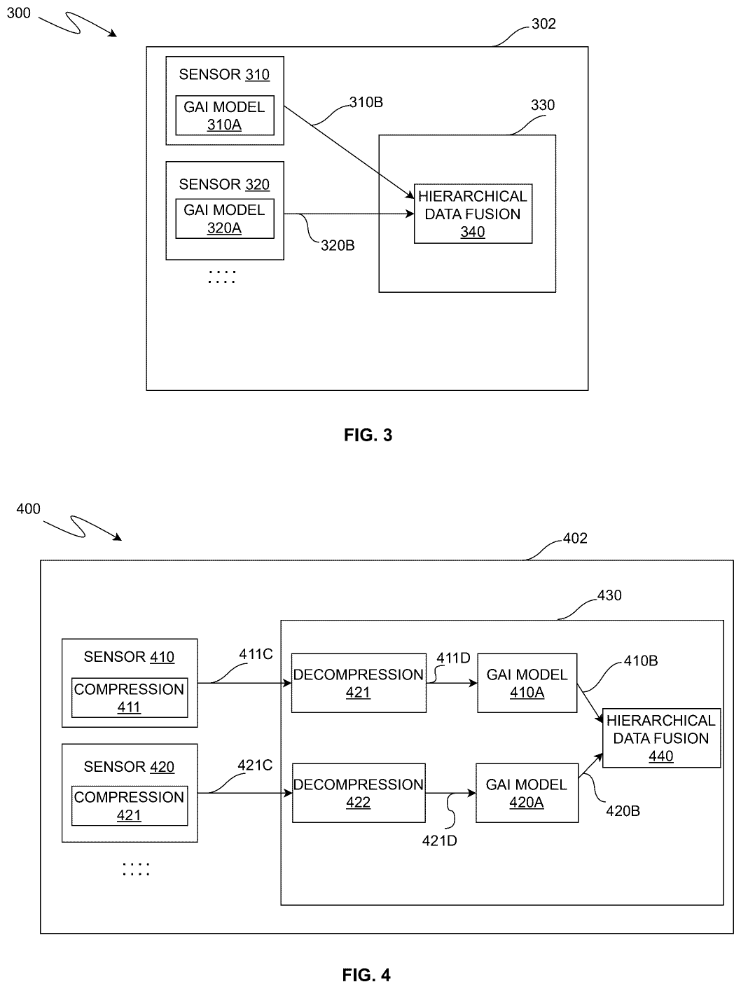

FIG. 3 shows a system 300 associated with a generative AI (GAI) based feature extraction. The system 300 may be configured for sensing operations in an environment 302. For example, the environment 302 may be a network environment including a network access node (e.g. network access node 110). The system 300 may include a number of sensor nodes (i.e. sensors). Although FIG. 3 illustrates sensor 310 and sensor 320 within the environment 302, this should not be taken as limiting since any number of sensors (e.g. N number of sensors, N being an integer greater than 1, such as 2, 3, 4, 5, 10, 20, etc.) deployed within the environment 302 may be possible along with their corresponding features and functions (i.e. environment sensing, environment monitoring, etc.). Such a scheme for expansion of the number of sensors within the system 300 is already implied with dotted lines in FIG. 3. Sensor 320 may be deployed in a different location from the sensor 310, and vice versa.

In some aspects, sensor 310 may generate a first sensor data (i.e. sensor data) (e.g. raw data) based on its respective monitoring and/or detections and sensor 320 may generate a second sensor data based on its respective monitoring and/or detections. In some examples, the type of first sensor data may be different from the type of second sensor data. In some examples, sensor data of sensor 310 and sensor data of sensor 320 may have different modalities. In other words, sensor data of sensor 310 may be based on a monitoring of the environment 302 according to a first modality and sensor data of sensor 320 may be based on a monitoring of the environment according to a second modality. Correspondingly, respective sensor data may be referred to be according to its respective modality.

For example, first sensor data associated with sensor 310 may be processed by a GAI model 310A. Similarly, second sensor data associated with sensor 320 may be processed by a GAI model 320A. One or more processors may implement GAI model 310A and GAI model 320A. Due to possible different modalities of sensor data, GAI model 310A may differ from the GAI model 320A. That is, GAI model 310A may be designed and/or developed to process data with a data type provided by sensor 310, while GAI model 320A may be designed and/or developed to process data with a data type associated with sensor 320. Thus, GAI model 310A and GAI model 320A may be generative models trained to process data with a corresponding data type pointing to certain or specific or predetermined modality. As denoted, one or more additional sensors may be deployed within the depicted scheme in FIG. 3, which results in employing different GAI models, provided that the one or more additional sensors are associated with different types of sensor data.

GAI model 310A may extract a feature 310B based on the sensor data from the sensor 310. GAI model 320A, on the other hand, may extract a feature 320B based on the sensor data from the sensor 320. In that sense, feature 310B and the feature 320B may be output data generated by corresponding GAI models (i.e. GAI models 310A, 310B), represented as features. The feature 310B and the feature 320B may share a common latent space. That is, the feature 310B may be within the same latent space associated with the feature 320B. A feature may refer to extracted characteristic information obtained from the sensor data, which is associated with the monitoring and/or detections performed by the respective sensor providing the sensor data. In some aspects, sensor data input to the GAI models may represent or attributed to high-dimensional data, and the features (e.g. feature 310B, feature 320B) may represent or attributed to the discriminative characteristics of the sensor data (e.g. high-dimensional data) in the latent space (e.g. a low-dimensional space.)

In some examples, a processor, which may be one or more processors or a further processor may implement feature fusion using feature 310B and feature 320B. Illustratively, the sensor 310 and the sensor 320 may be deployed within the environment 302 remote to an edge node that is referred to Edge 330. Correspondingly, the sensor 310 and the sensor 320 may communicate with the Edge 330, for example to send information representing feature 310B and feature 320B respectively. The Edge 330 may implement feature fusion with features obtained from the sensor 310 and the sensor 320.

For example, feature 310B and feature 320B may be transferred to the Edge 330 where a fusion network, such as a hierarchical data fusion 340 is implemented. A processor of the Edge 330 may implement the hierarchical data fusion 340. In such constellation, the hierarchical data fusion 340 may perform combining feature 310B and feature 320B to generate an output representing the combination. In other words, the output of the hierarchical data fusion 340 may be or include a combined feature (not shown) based on the feature 310B and feature 320B. In some aspects, the fusion network (i.e. hierarchical data fusion 340) may be trained in a way that the combined feature shares the same latent space of the feature 310B and feature 320B. Because the feature 310B and the feature 320B may be associated with different modalities, data fusion (i.e. feature fusion) performed at hierarchical data fusion 340 denotes multi-modal feature fusion. Furthermore, system 300 may be suitable for a device capable of implementing GAI models and a fusion network. Such capability may require an adequate level of computational power and resources. In that sense, a device capable of carrying out the scheme shown in FIG. 3 may be regarded as a high-power computing device.

FIG. 4 shows a system 400 associated with a generative AI (GAI) based feature extraction. Aspects described in FIG. 3 with respect to the sensors 310, 320 and the Edge 330 may apply to sensors 410, 420 and Edge 430 respectively as well. The system 400 may include an environment 402. In some examples, the environment 402 may be a network environment. The system 400 may include a number of sensor nodes (i.e. sensors). Although FIG. 4 presents sensor 410 and sensor 420 within the environment 402, this should not be taken as limiting since any number of sensors (e.g. N sensors as described in FIG. 3, etc.) deployed within the environment 402 may be possible along with their corresponding features and functions (i.e. environment sensing, environment monitoring, etc.). Such a scheme for expansion of the number of sensors within the system 400 is implied with dotted lines in FIG. 4. Sensor 420 may be deployed in a different location from the sensor 410, and vice versa.

In some aspects, sensor 410 may generate a first sensor data (i.e. sensor data) (e.g. raw data) and sensor 420 may generate a second sensor data and the type of first sensor data may be different from the type of second sensor data. In some examples, sensor 410 and sensor 420 may have different modalities as described for sensor 310 and sensor 320. First sensor data associated with sensor 410 may be compressed at Compression 411. Similarly, second sensor data associated with sensor 420 may be compressed at Compression 421. One or more processor may implement Compression 411 and Compression 421. Compression of data may be needed within the system 400 due to nodes where the sensors are deployed not having adequate computing capabilities to implement a GAI model for feature extraction.

The Edge 430 may receive compressed data 411C associated with the sensor 410 and compressed data 421C associated with the sensor 420. Edge 430 may include a processor capable of decompressing sensor data received from sensor 310 and sensor 320, implementing respective GAI models, and performing hierarchical feature fusion. For example, compressed data 411C and compressed data 421C may be decompressed at decompression 412 and decompression 422, respectively. The processor may further provide decompressed data 411D and decompressed data 421D to respective GAI models for feature extraction. The processor may implement GAI model 410A and GAI model 420A. For example, GAI model 410A may extract a feature based on the decompressed data 411D, which represents sensor data associated with the sensor 410. Likewise, GAI model 420A may extract a feature based on the decompressed data 421D, which represents sensor data associated with the sensor 420.

Due to possible different modalities presented by the sensor data, GAI model 410A may differ from the GAI model 420A. That is, GAI model 410A may be designed and/or developed to process data with a data type provided by sensor 410, while GAI model 420A may be designed and/or developed to process data with a data type associated with sensor 420. Thus, GAI model 410A and GAI model 420A may be generative models trained to process data with a corresponding data type pointing to a specific modality. As denoted, one or more additional sensors may be deployed within the depicted scheme in FIG. 3, which results in employing different GAI models, provided that the one or more additional sensors are associated with different types of sensor data.

Still referring to system 400 within FIG. 4, GAI model 410A may extract a feature 410B based on the decompressed data 411D (i.e. decompressed sensor data) in a latent space. On the other hand, GAI model 420A may extract a feature 420B based on the decompressed data 421D in the latent space. That is, feature 410B and feature 420B may share and be represented within the same latent space (i.e. common latent space).

Furthermore, the processor of the Edge 430 may implement a feature fusion network using feature 410B and feature 420B. A fusion network, such as a hierarchical data fusion 440 may perform combining of feature 410B and feature 420B. In such a constellation, the hierarchical data fusion 440 may perform combining feature 410B and feature 420B to generate an output representing the combination. In other words, the output of the hierarchical data fusion 440 may be or include a combined feature (not shown) based on the feature 410B and feature 420B. In some aspects, the fusion network (i.e. hierarchical data fusion 340) may be trained in a way that the combined feature shares the same latent space of the feature 410B and feature 420B. Because the feature 410B and the feature 420B may be associated with different modalities, data fusion (i.e. feature fusion) performed at hierarchical data fusion 440 denotes multi-modal feature fusion.

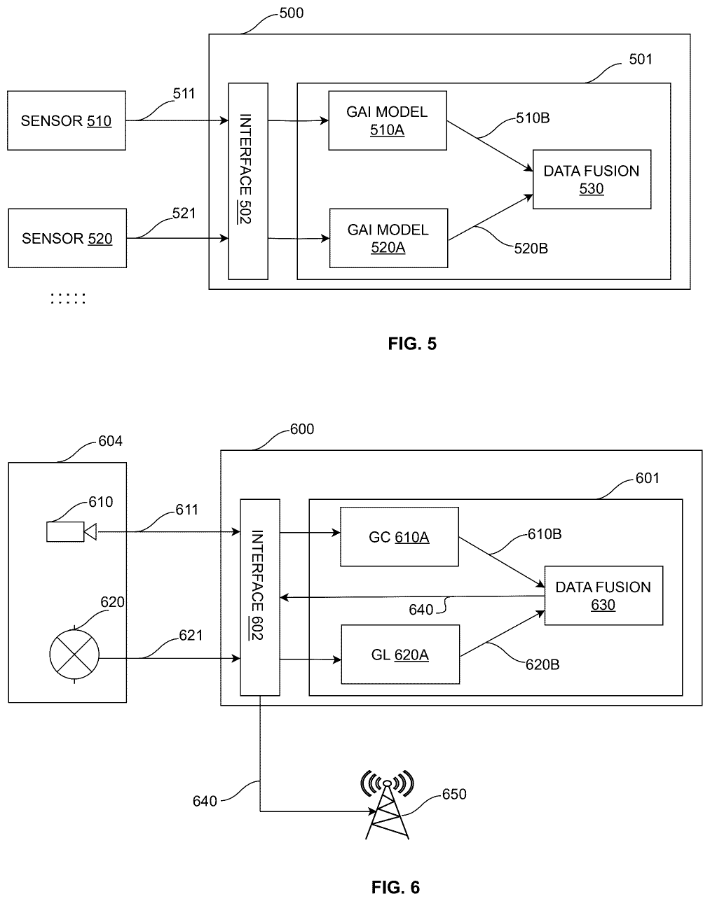

FIG. 5 shows a device 500 (i.e. apparatus) in accordance with various aspects disclosed herein. Illustratively, the device 500 may be a communication device (e.g. the communication device 200) as described herein. The device 500 may include a processor 501. The processor 501 may include a central processing unit, a graphics processing unit, a hardware acceleration unit, a neuromorphic chip, and/or a controller. The processor 501 may be implemented in one processing unit, e.g. a system on chip (SOC), or an integrated system or chip. The processor 501 may include one or more processors. The device 500 may further include a memory (not shown) to store data for related functions with respect to the device 500. In various examples, the processor 501 and the memory (and also other various components of the device not shown) may be communicatively coupled over an internal interface to communicate signals or data (e.g. a bus, wires, etc.).

Furthermore, the device 500 may include an interface 502 (e.g. a communication interface). The interface 502 may manage any type of communication with other devices (e.g. sensor 510, sensor 520) for the device 500. The interface 502 may be communicatively coupled to the other devices (via wired or radio communication), and the communication interface 406 may provide the data received from the other devices to the processor 501. The interface 502 may receive the data over a communication network or via peer-to-peer communication (e.g. ad-hoc) from the other devices. Furthermore, the interface 502 may transmit data to the other devices. The interface 502 may support any one or more of the communication protocols or communication technologies, some of which are exemplarily provided in this disclosure. In accordance with various aspects of this disclosure, the device 500 may be communicatively coupled to various devices (e.g. sensor 510, sensor 520, etc.) over the interface 502.

The processor 501 is depicted to include various functional modules that are configured to provide various functions respectively. The skilled person would recognize that the depicted functional modules are provided to explain various operations that the processor 501 may be configured to. The processor 501 may include one or more trained GAI models and a data fusion block.

Referring to FIG. 5, sensor 510 and sensor 520 may be deployed so that it can monitor an environment (e.g. a network environment, a designated environment such as a factory, a warehouse, a road environment, etc.). In some aspects, sensor 510 and sensor 520 may be included in the device 500. In some examples, sensor 510 and sensor 520 may be respective sensor nodes communicatively couplable to the device 500. Sensor 510 may be associated with a sensor type different from the type of the sensor 520, and vice versa. Therefore, while sensor 510 may generate sensor data representing the environment monitoring according to a modality, sensor 520 may generate sensor data representing the environment monitoring according to another modality different from the modality associated with the sensor 510.

Sensor 510 may transmit corresponding sensor data 511 and sensor 520 may transmit corresponding sensor data 521. Although FIG. 5 depicts sensor 510 and sensor 520, the skilled person would immediately recognize and appreciate that the number of sensors may be expanded such that one or more additional sensors may present another sensor type different from the types of sensor 510 and/or sensor 520. Such a scheme would bring that another sensor (not shown) may monitor the environment according to a modality different from the modalities associated with sensor 510 and/or sensor 520.

The device 500 may receive sensor data 511 and sensor data 521 via the interface 502. The interface 502 may receive sensor data 511 and sensor data 521, and the processor 501 may obtain sensor data 511 and sensor data 521. In some aspects, the processor 501 may determine the modality of received sensor data in order to provide the corresponding sensor data to a respective trained GAI model. Exemplarily, the processor 501 may determine that the sensor data 511 includes a first modality. In such a case, the processor 501 may provide the sensor data 511 to the input of corresponding GAI model 510A. Accordingly, the processor 501 may determine that the sensor data 521 includes a second modality, and may provide the sensor data 521 to the input of corresponding GAI model 520A.

In some aspects, GAI model 510A may perform feature extraction based on the sensor data 511 and GAI model 520A may perform feature extraction based on the sensor data 521. Therefore, GAI model 510A may output data including a feature 510B in a latent space and GAI model 510B may output data including a feature 520B in the latent space. In some examples, the feature 510B and the feature 520B may be associated with the same latent space. Each of feature 510B and feature 520B may be referred to as an extracted feature. Illustratively, GAI model 510A may be trained to generate the output data based on its respective input sensor data of a first modality and GAI model 510B may be trained to generate output data based on its respective input sensor data of a second modality. Furthermore, feature 510B and feature 520B may represent sensing of the environment according to corresponding modalities and performed by the corresponding sensors (i.e. sensor 510 and sensor 520).

The processor 501 may combine feature 510B and feature 520B via a data fusion 530. Data fusion 530 performed by the processor 501 may aim to generate a combined feature based on the feature 510B and feature 520B. The combined feature (not shown) may represent a feature of the environment monitored and/or sensed by the sensor 510 and sensor 520. The combined feature may further be associated with the modalities brought about by the types of sensor 510 and sensor 520. In that sense, the combined feature may be based on the modality associated with the sensor 510 and the modality associated with sensor 520. Therefore, data fusion 530 may denote a multi-modal feature fusion. In some cases, the processor 501 may generate/extract the combined feature in the same latent space of feature 510B and feature 520B. As disclosed herein, the same latent space may refer to a latent space in which data associated with different modalities are mapped into a common latent space. Therefore, the same latent space may be understood as “common latent space”. In some aspects, the device 500 may include a transceiver to communicate with a communication device.

FIG. 6 shows a device in accordance with various aspects of the disclosure. The device 600 may include similar characteristics and capabilities pertaining to the device depicted in FIG. 5 (i.e. device 500). As denoted, different type of GAI models may be utilized for different sensor data type due to different modalities in which the sensor data is used as input to the corresponding GAI model. Exemplarily, FIG. 6 depicts the device 600 and the processor 601 of the device 600, which the processor 601 may implement a variety of GAI models based on the input (e.g. sensor data). FIG. 6 further depicts sensors, such as a camera 610 and a Lidar 620, noting that they can be any type of sensors of different modalities and provided herein with examples of camera 610 and Lidar 620 for illustrative purposes. Camera 610 may monitor an environment (e.g. a network environment) according to the respective modality (e.g. first modality). in order to provide its respective sensor data (e.g. first sensor data). Furthermore, Lidar 620 may monitor the environment according to the respective modality (e.g. second modality) in order to provide its respective sensor data (e.g. second sensor data).

In some aspects, camera 610 and Lidar 620 may be sensors deployed and/or integrated into a sensor node 604 or a sensor network. In some aspects, the device 600 may include the sensor node 604 involving camera 610 and the Lidar 620. Therefore, data associated with environment sensing/monitoring may refer to environment sensing data measured by the sensor node 604 (e.g. sensors of the device 600). The device 600 may be within a cellular communication network (e.g. radio communication network 100). In some examples, the device 600 may be referred to as a communication device (e.g. communication device 200) or a user equipment (UE), which may be stationary or mobile. Thus, in some aspects, the device 600 may include a transceiver to communicate with another communication device.

In some aspects, sensor node 604 may provide first sensor data 611 associated with the respective modality. Further, sensor node 604 may provide second sensor data 621. As FIG. 6 depicts different sensor types, the skilled person would immediately recognize that the modalities associated with the sensors (i.e. camera 610 and Lidar 620) are different from each other. In this respect, sensor node 604 may transmit the first sensor data 611 and the second sensor data 621 to the device 600 via interface 602.

In some aspects, the processor 601 may determine the modality of received sensor data in order to provide the corresponding sensor data to a respective trained GAI model. Exemplarily, the processor 601 may determine that the sensor data 611 is of a first modality. In such a case, the processor 601 may provide the sensor data 611 to the input of the corresponding GAI model, namely GAI model camera GC 610A. Accordingly, the processor 601 may determine that the sensor data 621 is of a second modality, and may provide the sensor data 621 to the input of corresponding GAI model, namely GAI model Lidar GL 620A.

GAI model camera GC 610A may be implemented to process the first sensor data 611 in which the first sensor data 611 is associated with the first modality. GAI model camera GC 610A may generate output data including a feature 610B based on the first sensor data 611 in a latent space. Accordingly, GAI model Lidar GL 620A may be implemented to process the second sensor data 621 in which the second sensor data 621 is associated with the second modality. GAI model Lidar GL 620A may generate output data including a feature 620B based on the Second sensor data 621 in the latent space. Therefore, GAI models may perform feature extraction based on the corresponding sensor data. As disclosed, the latent space herein may stand for a common latent space.

The processor 601 may process the output data generated by GAI model camera GC 610A and GAI model Lidar GL 620A. In some aspects, the processor 601 may implement data fusion 630 (i.e. data fusion network) in order to combine the feature 610B and feature 620B. The processor 601 may generate an output representing a combined feature 640 based on the feature 610B and feature 620B. The combined feature 640 may be in the common latent space and represent a feature of the environment. In some aspects, data fusion 630 may refer to multi-modal data fusion network due to the different modalities involved in the first sensor data 611 and second sensor data 621.

In accordance with various aspects disclosed herein, the processor 601 may transmit the combined feature 640 through interface 602 to another node (e.g. a device, a further communication device, a network access node, etc.) within the communication network. Exemplarily, the processor 601 may transmit the combined feature to another communication device. In some examples, the processor 601 may encode and transmit the combined feature through interface 602 to a further communication device 650. The further communication device 650 may be, illustratively, a network access node within a cellular communication network. In some examples, the further communication device 650 may be a further communication device including a device configured same as the device 600. In some aspects, the combined feature 640 may be used as an input to a further fusion network. The further fusion network may implement a hierarchical combining of inputs (i.e. input data, input features) and generate another combined feature based on the inputs. In some examples, the device 600 may communicate with the further communication device 650 bidirectionally also by receiving information from the further communication device 650. Illustratively, the further communication device 650 may include a device configured same as the device 600 and may provide feature information to the device 600 via the communication network. In an example, the processor 601 may encode the combined feature 640 and provide the combined feature 640 over the interface 602 to the further communication device 650.

In some examples, the device 600 may receive a feature information from a further communication device (e.g. the further communication device 650). The feature information may include/represent a feature indicating the monitoring of an environment associated with the further communication device. Moreover, the feature information may be within the common latent space. In some cases, the environment associated with the further communication device may be different from the environment monitored by the sensors included in the sensor node 604. That is, the further communication device may be an arbitrarily deployed device. Additionally, or alternatively, the further communication device may refer to a geographically distributed device compared to the location of the sensor node 604 (i.e. accordingly, location of the device 600). Therefore, the further communication device may point out a physical distance from the device 600 such that the further communication device is attributed to another environment.

In some aspects, the feature information may be received through the interface 602. The processor 601 may decode the feature information. Furthermore, the feature information received from the further communication device may be used as an input to the data fusion 630 (i.e. data fusion network). In such a case, the processor 601 may exemplarily perform combining of the feature 610B, feature 620B, and the feature information (i.e. feature representing the monitoring of the other environment). In such constellation, the combined feature may be further based on the feature information in addition to feature 610B and feature 620B. The processor 601 may further process the combined feature for decision making process. In some examples, the decision-making may include object detection, object classification, segmentation, etc.

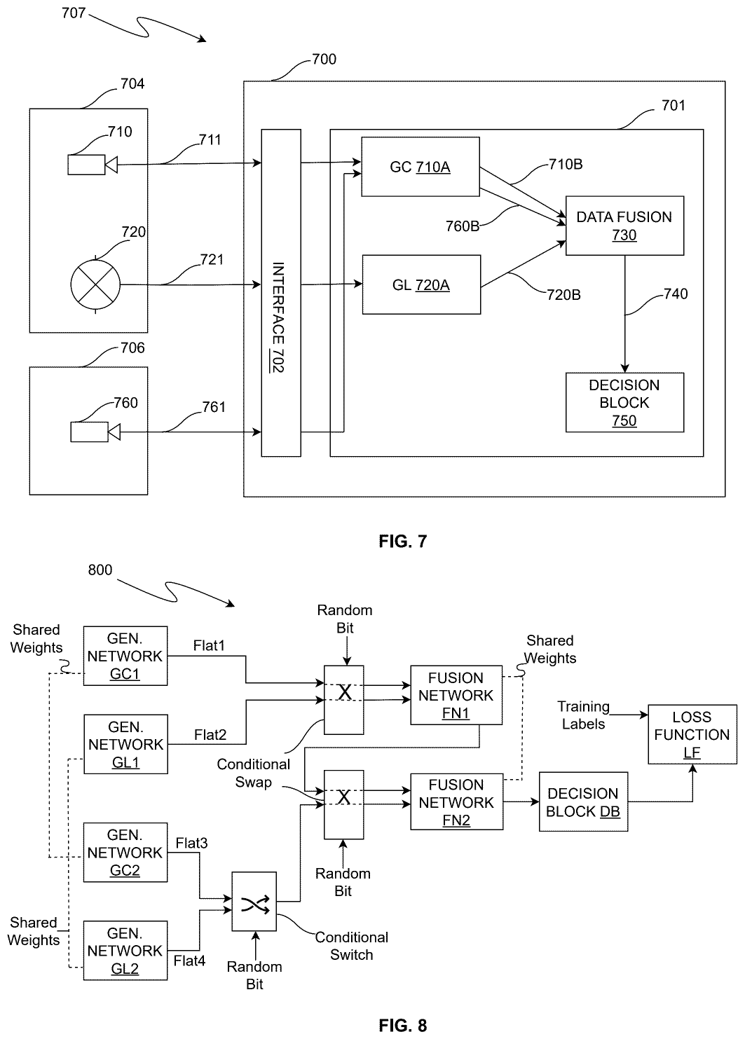

FIG. 7 shows an environment 707 and a device 700 in accordance with various aspects disclosed herein. Aspects described herein for devices herein (e.g. the device 500, the device 600) may also apply to the device 700. A sensor node 704 may be within the environment 707 and sensors of the sensor node 704 may perform monitoring of the environment 707. In that sense, the sensor node 704 may resemble the sensor node 604 in FIG. 6. In some aspects, the device 700 may include the sensor node 704. As shown, the sensor node 704 may include a camera 710 and a Lidar 720, each of which provides sensor data according to a modality determined by the sensor type. Exemplarily, the sensor node 704 may provide camera sensor data 711 according to a first modality, and the Lidar sensor data 721 according to a second modality. It is to be noted that sensors depicted herein can be any type of sensors of different modalities and provided herein with examples of camera and Lidar for illustrative purposes. The sensor node 704 may provide corresponding sensor data to a device 700 through an interface 702. The device 700 may include a transceiver to communicate with another communication device.

FIG. 7 further depicts an additional communication device 706 within the environment 707. The additional communication device 706 may include a camera 760, which may refer to a camera with identical, similar, or comparable sensor capabilities of the camera 710 of the communication device 704. Therefore, the camera 760 of the additional communication device 706 may monitor the environment 707 according to the first modality. In such a scheme, the additional communication device 706 may provide a camera sensor data 761 to the device 700 through the interface 702.

Illustratively, the device 700 (e.g. the device 500, the device 600) may determine, via a processor 701 (e.g. processor 501, processor 601), modalities associated with the sensor data. In a similar manner to FIG. 6, the processor may determine that the camera sensor data 711 is associated with the first modality and the Lidar sensor data 721 is associated with the second modality. Accordingly, the processor 701 may provide respective sensor data to the input of corresponding GAI models. Illustratively, the camera sensor data 711 may be input to the GAI model camera GC 710A, and the Lidar sensor data 721 may be input to GAI model Lidar GL 720A. As denoted, such GAI models may be trained accordingly to process corresponding data based on the modality. In some examples, the processor 701 may further implement the GC 710A and GL 720A.

Furthermore, the processor 701 may decode the camera sensor data 761 and determine that the camera sensor data 761 is also associated with the first modality. Since the GAI model camera GC 710A refers to a GAI model trained to process the camera sensor data based on the modality, the processor 701 may provide the camera sensor data 761 to the input of GAI model camera GC 710A. In some aspects, the additional communication device 706 may include a sensor type different from the camera 710 (and the camera 760 for that matter), and the Lidar 720 (e.g. an infrared camera, a radar, etc.). In that case, such a sensor may monitor the environment 707 according to another modality (e.g. a third modality). The skilled person would immediately recognize that the device 700 may employ a corresponding trained GAI model different from the GAI model camera GC 710A and the GAI model Lidar GL 720A in order to process and extract a feature from the sensor data of such sensor.

The GAI model camera GC 710A may process the camera sensor data 711 to generate a corresponding output data. Illustratively, the GAI model camera GC 710A may perform feature extraction from the camera sensor data 711. Therefore, the output data may include a feature 710B (e.g. a feature vector) based on the camera sensor data 711 in a common latent space. Accordingly, the GAI model camera GC 710A may also process the camera sensor data 761 to generate a corresponding output data. Illustratively, the GAI model camera GC 710A may perform feature extraction from the camera sensor data 761. Therefore, the output data may include a feature 760B (e.g. a feature vector) based on the camera sensor data 761 in the common latent space.

In some examples, the GAI model camera GC 710A may be trained to aggregate and/or merge the camera sensor data 711 and the camera sensor data 761 by employing known data aggregation techniques. Such aggregation may enable the GAI model camera GC 710A to generate aggregated and/or merged output data including an aggregated feature. Illustratively, the GAI model camera 710A may output a locally merged feature based on the corresponding inputs with identical modality rather than outputting distinct features, such as feature 710B and feature 760B as shown.

Furthermore, the GAI model Lidar GL 720A may process the lidar sensor data 721 to generate a corresponding output data. Illustratively, the GAI model Lidar GL 720A may perform feature extraction from the Lidar sensor data 721. Therefore, the output data may include a feature 720B (e.g. a feature vector) based on the Lidar sensor data 721 in the common latent space. The processor 701 may implement a data fusion 730 (i.e. data fusion network) in order to generate a combined feature based on the feature 710B, feature 720B, and feature 760B. The combined feature 740 may be in the same latent space (i.e. the common latent space) with the input features.

In some examples, the processor 701 may provide the combined feature 740 to input of a decision block 750. The decision block 750 may be an AI/ML unit configured to process the combined feature 740 for performing decision-making. Therefore, the decision block 750 may perform various decision processes including but not limited to object identification, object detection, semantic segmentation, etc. based on the combined feature 750. Accordingly, the decision block 750 may generate an output (not shown) representing a decision based on the combined feature.

In some aspects, the additional communication device 706 may provide data representing measurements of a network (e.g. network environment) instead of camera sensor data 761. Such network measurement data may exemplarily include RAN measurements of the network. In such a scheme, the processor 701 may determine that the network measurement data is associated with another modality different (e.g. a third modality). In such a case, the processor may implement another GAI model (not shown) trained to process and generate another feature (e.g. instead of the feature 760B) from the network measurement data. Therefore, the processor 701 may combine the features 710B, 720B, and the another feature in the data fusion 730 (i.e. data fusion network) to generate another combined feature based on the features 710B, 720B, and the another feature.

Although FIGS. 5, 6 and 7 illustrate a transmission of sensor data to a device (e.g. device 500, device 600, device 700), it may be possible, in some cases, for a communication device (e.g. communication device 200) to provide sensor data in a compressed manner, leveraging the structure exemplified in system 400. In such a case, corresponding sensor data of one or more sensors associated with the communication device may be compressed using a data compression technique. Exemplarily, the communication device may include a camera for monitoring an environment (e.g. network environment). The communication device may compress camera sensor data using standards-based point cloud compression or AI-based point cloud compression for transmission.

In some examples, the communication device may transmit compressed sensor data to the device (i.e. the device 500, the device 600, or the device 700) over a network access node (e.g. network access node 100) serving as a base station within the environment. In some examples, transmission of sensor data may be performed over a wireless medium (e.g. over-the-air interface). The network access node may employ the device including an interface (e.g. interface 502), a processor (e.g. processor 501) in which the processor may implement a trained GAI model (e.g. GAI model 510A) based on the modality associated with the input sensor data.

In some aspects, the processor may decompress the compressed sensor data in order to provide the decompressed data to input of the corresponding GAI model. The GAI model may process the decompressed data (i.e. decompressed sensor data) in order to perform feature extraction, thereby generating output data including a feature based on the decompressed sensor data. In some examples, the device may be a device of the network access node. In further examples, the device may be able to implement, via the processor, further GAI models for sensor data representing another modality received from further communication devices. The device may be further able to implement, via the processor, the same GAI model (i.e. GAI model used for the decompressed sensor data) in order to process further sensor data representing the same modality with the decompressed sensor data. Those examples may not be taken as limiting, as the skilled person would appreciate the possibility of enforcing other examples without departing from the described details of the invention.

In accordance with various aspects disclosed herein, there may be certain use-case scenarios in which sensors such as camera, Lidar, and other type of sensor nodes (e.g. infrared camera, radar, etc.) with different field-of-view are geographically distributed e.g. in an environment (e.g. network environment). Therefore, it may not be a trivial task to generate/extract features from sensor data associated with a specific sensor node in which the generated/extracted feature could be efficiently combined with features (e.g. a feature vector) associated with sensor data of another arbitrarily deployed/located sensor node. Notably, such arbitrarily located sensor node (i.e. sensor) may have a different field-of-view and potentially different sensor type.

In some aspects, in order to efficiently perform the fusion of multi-modal features from multiple sensor nodes monitoring an environment according to a respective modality, a promising method may be to generate the features based on the sensor data from different sensor nodes in a common latent space in which the generated features can represent the environment information comprehensively and concisely. As denoted GAI models described within the disclosure may be trained models. However, it is challenging to train such models (e.g. a deep learning-based network) that can generate/extract features (e.g. a feature vector) from different sensor data received from different sensors with potentially different sensor types signaling different modalities.

This challenge about training a generative network may be mainly due to lack of training data that can represent the unknown latent space for different sensor types and different field-of-view. To triumph over this challenge, a generative fusion network and a method to train the generative fusion network may be presented. Such a network may train generative AI-based models e.g. a deep learning model to generate/extract features in the common latent space.

FIG. 8 shows a training scheme 800 of generative AI-based Models and data fusion networks. Generator networks GC1, GL1, GC2, and GL2 may be deep learning neural networks that may include a variety type of layers, such as convolutional layers, fully connected layers, attention layers, etc. The ultimate goal of the generator networks may be to process corresponding input data (e.g. corresponding sensor data and metadata), perform feature extraction, and translate the features of input data into a feature vector (i.e. latent space vector). In accordance with various aspects described herein, the processor of the devices described herein (e.g. the device 500, the device 600, the device 700) may implement the training scheme 800.

Illustratively, generator network GC1 may be provided with camera sensor data received from a camera, along with accompanying metadata associated with the camera including field-of-view, etc. Generator network GC1 may be trained using the training scheme 800 to process the input data (i.e. camera sensor data and metadata) received from the camera to generate a feature vector Flat1. Accordingly, generator network GL1 may be provided with Lidar sensor data received from a Lidar, along with accompanying metadata associated with the Lidar including field-of-view, etc. Generator network GL1 may be trained using the training scheme 800 to process the input data (i.e. Lidar sensor data and metadata) received from the camera to generate a feature vector Flat2.

Furthermore, depending on the data type of input data, different type of generator networks may also be trained in accordance with the training scheme 800. The internal architecture of a generator network may be of any type that is appropriate for the input data type. Therefore, a generator network may be able to learn to translate corresponding sensor data (as input data) into a feature vector. Examples for such generator networks may include transformers, diffusion models, etc. Although FIG. 8 depicts a two different types of generator networks, the skilled person would immediately recognize that the training scheme 800 may be extended to include any number of generator networks in which the different type of generator networks may be included for different type of sensors (and accordingly different type of sensor data).

In some aspects, shape and size of the output feature vectors generated by generator networks may be the same. That is, feature vectors may have the identical features in terms of dimensionality so that the feature vectors do not create incompatibility for a data/feature fusion process. As denoted, the input data to a corresponding generator network may include corresponding sensor data and metadata. Exemplarily, the input data to generator network GC1 (and GC2) may include RGB image data and the input data to generator network GL1 (and GL2) may include point-cloud data. In some aspects, the metadata provided as part of a corresponding input data may include field-of-view information and other information that may aid the respective generator network in generating an accurate output.

In accordance with various aspects disclosed herein, the output of a generator network may be a feature vector of an invariable length. Illustratively, generator network GC1 may output the feature vector Flat1 of length N-lat, and generator network GL1 may output the feature vector Flat2 of the identical length, N-lat. The training process illustrated in the training scheme 800 may be designed in a such way that the generator networks e.g. GC1 and GL1 may generate corresponding feature vectors in the common latent space by training generator networks GC1 and GL1 together with common end-to-end loss.

FIG. 8 further depicts additional instances of each type of generator network models. Specifically, generator network GC2 and generator network GL2 may be additional instances of generator networks. Exemplarily, generator network GC2 may generate a feature vector from the same type of input data provided to generator network GC1. Accordingly, generator network GL2 may generate a feature vector from the same type of input data provided to generator network GL1. In some aspects, generator networks may be trained with a set of weight parameters. The weight parameters may train corresponding generator networks, thereby causing the corresponding generator networks to generate a corresponding output (i.e. corresponding feature vectors). Exemplarily, the generator network GC1 may be trained with a first set of weight parameters and the generator network GL1 may be trained with a second set of weight parameters.

In some aspects, pair of generator networks GC1-GC2 and GL1-GL2 may output corresponding feature vectors based on corresponding weight parameters that include shared weights in order to enable two-stage hierarchical fusion (i.e. hierarchical data fusion). In some examples, the shared weights may ensure that the same model parameters are used in both stages of the hierarchical fusion. Completion of the training scheme 800 may enable generator network pairs to form a unified trained model in order to act and perform as a trained GAI model (e.g. GAI model camera GC 710A, GAI model Lidar GL 720A, etc.)

The training scheme 800 further depicts fusion network. The ultimate goal of a fusion network (i.e. data fusion network) may be to combine features (i.e. feature vectors) generated by corresponding generator networks. For example, a fusion network may combine a feature vector generated by the generator network GC1 and a feature vector generated by the generator network GL1. Such combination may lead to a resulting feature vector in the common latent space. That is, the fusion network may generate an output representing a feature vector in the common latent space based on the input feature vectors. The output of the fusion network may be in the common latent space so that the resulting feature vector may be used as an input at a further fusion network. Such a scheme may cause a performable hierarchical data fusion.

The training scheme 800 depicts a pair of fusion networks (i.e. fusion network models). In detail, the training scheme 800 shows a fusion network FN1 and a fusion network FN2 trained with weight parameters. In some aspects, weight parameters associated with fusion networks FN1 and FN2 may include shared weights in which output of fusion network FN1 is used as input for fusion network FN2. Such constellation may ensure that a fusion network (e.g. FN1) generates output that is acceptable as an input for another fusion network (e.g. FN2) or a decision-making network (e.g. decision block DB). Using shared weights may indicate that the same fusion network is replicated for the fusion network to learn performing data fusion with its own output as an input to the replicated one. Therefore, in accordance with various aspects of the disclosure, fusion network FN2 may refer to a copy of the fusion network FN1.

Furthermore, whilst an input to the fusion network FN2 may be the output of the fusion network FN1, another input may be based on features generated by a pair of generator networks. Illustratively, as fusion network FN2 may be provided with the output of the fusion network FN1 on one hand, another input may be a feature output randomized between the outputs generated by the generator networks GC2 and GL2. Such randomization may be performed by introducing a conditional switch applied on the outputs (i.e. feature outputs, feature vectors, etc.) generated by the generator networks GC2 and GL2. Therefore, creating a copy of the fusion network FN1 with shared weights to emerge the fusion network FN2 may lead to (e.g. upon completion of the training scheme 800) obtaining a fusion network model that is capable of combining multiple features (e.g. feature vectors), each generated by a corresponding GAI model. Additionally, or alternatively, such a fusion network model may also combine a feature (e.g. feature vector) associated with respective sensor data and a feature generated by another fusion network (e.g. a priori fused feature).

In some aspects, the output feature generated by the fusion network FN2 may be an input for a decision block DB. The decision block DB may refer to a decision-making network that generates output based on the corresponding feature. Depending on the information represented and/or encompassed by the feature, the decision block DB may generate an output which may be exemplarily associated with object identification, object detection, semantic segmentation, etc. The output of the decision block DB may be provided as an input parameter to a loss function LF block for use in a back propagation algorithm during the training process within the training scheme 800. The loss function LF block may also be provided with training labels. Such training labels may include ground truth data (i.e. labelled data) based on the application. Therefore, the training labels may include ground truth data related with e.g. an object, etc.

Furthermore, the training scheme 800 shows conditional switch and conditional swap operations applied to realize a switching/swapping of output features of corresponding generator networks (e.g. Flat1-Flat2, Flat3-Flat4, etc.) and/or to output feature of the fusion network (e.g. FN1) and the resulting feature based on the conditional switch (e.g. either Flat3 or Flat4, etc.). Such conditional switching/swapping operations may regularize the learning of networks within the training scheme 800 and may be helpful to avoid overfitting. Those operations may force the output features of all the generator networks to be in the common latent space.

In some aspects a network access node include a scheduler that operates by intelligently processing inputs such as CSI, Buffer Status Report (BSR), traffic demand, user priority level, quality of service (QoS) requirement, network congestion information, user mobility, etc. Leveraging these inputs, the scheduler dynamically allocates spectrum resources, ensuring seamless and reliable communication. The base station scheduler may be inherently complex due to the dynamic nature of a cellular communication network environment.

In some aspects, the base station scheduler must manage a number of connected devices (e.g. user devices) with varying data demands, mobility patterns and signal conditions. Furthermore, the base station scheduler must constantly adapt to real-time changes within the cellular communication network including CSI/CQI. Such adaption to real-time changes may elevate the complexity of the base station scheduler. The current solutions aiming more efficient base station scheduler are not optimal due to the large dimensionality of the optimization space.

Recently, in the latest 3GPP release Rel-18, a new study item is being studied to use AI to compress and/or predict future CSI and transmit the compressed and/or predicted CSI to the network access node (e.g. base station). Such a scheme may be used for more effective scheduling purposes. A GAI-based scheduler (i.e. base station scheduler) mechanism aimed at optimizing the large parameter space may be provided. The GAI-based scheduler may empower the scheduler to make better-informed decisions. Such decision may in turn result in optimized data flow, reduced latency, and an enhanced user experience in the 5G and beyond cellular communication network ecosystem.

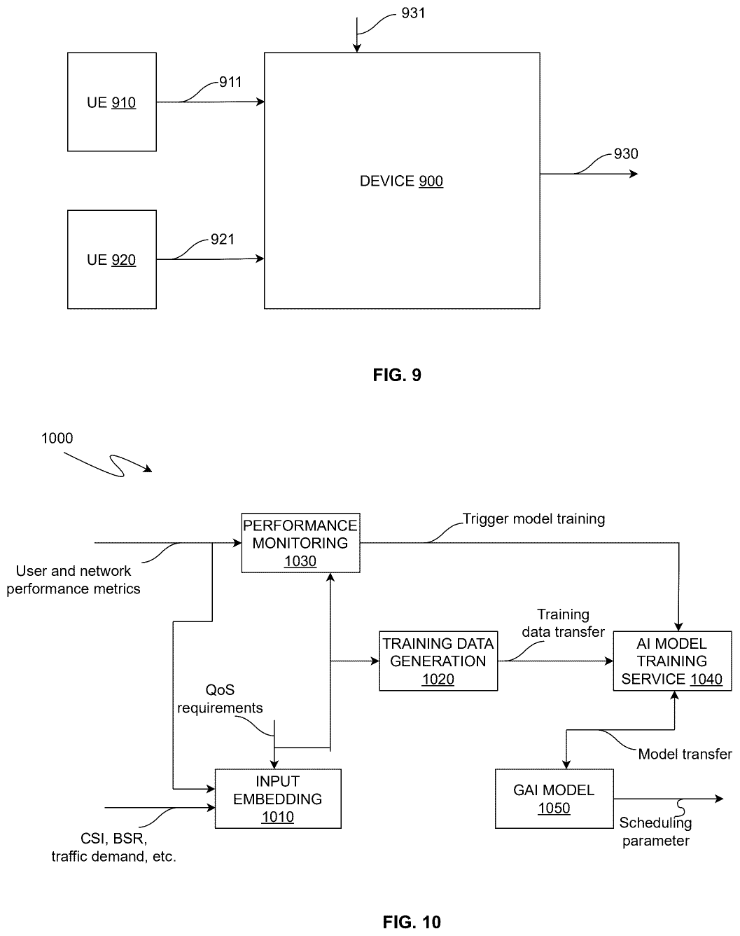

FIG. 9 depicts a device 900 (i.e. apparatus) in accordance with various aspects of the disclosure. The device 900 may perform one or more tasks to generate scheduling parameters for one or more UEs within a cellular communication network. In some examples, the device 900 may be a device of a network access node (e.g. network access node 110) within a cellular communication network (e.g. radio communication network 100). The network access node may refer to or include a base station serving to a plurality of UEs (e.g. terminal device 102, terminal device 104, communication device 200, etc.) within an environment (e.g. a network environment). In some aspects, each or some of the UEs may receive from and/or transmit information to the network access node.

In accordance with various aspects disclosed herein, the device 900 may include a processor (e.g. processor 501, processor 601, processor 701, etc.). Furthermore, the device 900 may include an interface (e.g. interface 502, interface 602, interface 702) for receiving from or transmitting information to the device 900. In some cases, the device 900 may receive UE-specific information from one or more of the UEs. Further, the device 900 may transmit scheduling information of one or more of the UEs. The processor of the device 900 may implement a GAI-based model in order to generate corresponding scheduling information for the respective UE.

Illustratively, FIG. 9 depicts UE 910 and UE 920. UE 910 and UE 920 may transmit corresponding UE-specific information to the device 900 of the network access node (e.g. network access node 110). In some aspects, UE-specific information may include CSI, BSR, traffic demand, priority level, QoS requirements, user mobility, etc. Furthermore, the device 900 may receive network-specific and/or base station-specific information. The network-specific and/or base station-specific information may include network congestion notification, interference information, etc. The processor of the device 900 may receive UE-specific information along with the network-specific information in order to provide those information to input of a trained GAI model to generate a scheduling parameter of one or more UEs within the cellular communication network. Although FIG. 9 shows a limited number of UE instances (i.e. UE 910 and UE 920), it is typical for a network access node to serve a greater number of UEs. Therefore, UE 910 and UE 920 may be taken as exemplary devices for illustrative purposes only.

In some examples, UE 910 and UE 920 may provide corresponding UE-specific information to the device 900. The processor of the device 900 may obtain such information e.g. via the interface. Exemplarily, UE 910 may transmit UE-specific information 911 and UE 920 may transmit UE-specific information 921. Furthermore, the processor of the device 900 may obtain network-specific (and/or base station-specific) information 931. In some examples, the device 900 may obtain UE-specific information 911 and UE-specific information 921 from a memory. Illustratively, UE-specific information may include any type of information that is specific to its respective UE within the cellular communication network.

In some examples, the processor of the device 900 may implement a trained GAI model. The processor may provide the UE-specific information 911, UE-specific information 921, and network-specific information 931 to input of the trained GAI model. The GAI model may output data including a scheduling parameter of one or more UEs associated with the network access node within the cellular communication network. The scheduling parameter may include user selection, resource selection, transmit Tx parameter selection, etc. In some cases, resource selection may exemplarily include radio resources such as frequency, time, space, code, etc. The skilled person would recognize that the number of network access nodes may be extended in accordance with the number of UEs (e.g. number of UEs served by the corresponding base station, etc.), which may result in extending the number of devices (i.e. device 900) as the device 900 is a device of a network access node. In some examples, the processor of the device 900 may schedule a communication resource to communicate with the multiple UEs (e.g. UE 910, and UE 920, etc.) based on the output data. In some aspects, the processor of the device 900 may encode information indicative of a communication resource for a transmission to at least one UE of the multiple UEs within the cellular communication network.

FIG. 10 shows an example of a block diagram 1000 that the device 900, an especially the processor of the device 900, may implement. The block diagram 1000 may refer to or include functional blocks associated with the trained GAI model, which generates scheduling parameter as exemplified in FIG. 9. An input embedding block 910 may combine input parameters provided to the device 900 and map the input parameters to a feature space in order to generate a feature vector. Notably, the device 900 may take a variety of input parameters associated with different data types, classes, and units. Accordingly, the input parameters may include measurement inputs, KPIs, and QoS requirements. The measurement inputs may include various user-level parameters (e.g. UE-specific information) such as CSI, user traffic per application flow, BSR, user mobility (e.g. user location, UE location, etc.) and the like. Furthermore, the input parameters may include network-level parameters (e.g. network-specific information) such as network traffic congestion, interference, etc.

In some examples, KPI inputs (i.e. KPIs) may include the measured user and network performance metrics such as UPT, latency, system throughput, etc. The QoS requirements may include user-level parameters such as packet delay budget, required packet error probability, priority level, and the like. In some aspects, the input data may be in different numerical ranges. Exemplarily, latency may be represented within the range of a few milliseconds, while the system throughput may be represented with tens of megabits per second (Mbps). Therefore, input data may require to be scaled to introduce a comparable range for a GAI model to learn in an efficient manner. Projecting such inputs to a multi-dimensional feature space—in which the input to the GAI model are feature vectors—may facilitate the learning process for e.g. the attention mechanism of the GAI model (e.g. a transformer). The term “learning” herein may refer to learning of the context.

Block diagram 1000 further depicts a training data generation block 1020. In some examples, feature vectors provided to input of the GAI model may be stored and/or cached. The training data generation block 1020 may leverage stored/cached feature vectors in order to generate training data. Such generated data may be used for retraining purposes (i.e. retraining of the GAI model). In some aspects, initial training of the GAI model may not cover all possible scenarios. Exemplarily, initial training of the GAI model may include a feature vector based at least in part on a latency input which is an outlier in most of the real-life scenarios. Therefore, if encountered certain real scenarios, the GAI model may not perform well enough to provide a satisfactory performance.

In some examples, changes regarding the environmental conditions, QoS requirements, and other factors may affect the performance of the GAI model generating a scheduling parameter, which may result in degradation of performance of the cellular communication network. In such cases, the training data generation block 1020 may enable the GAI model to be trained with real datasets stored/cached.

Block diagram 1000 further illustrates a performance monitoring block 1030. The performance monitoring block 1030 may compare the QoS requirements and network KPI requirements with the measured KPIs. Based on the comparison, the performance monitoring block 1030 may trigger the retraining of the GAI model. Such triggering may refer to conditional training based on a set of configured conditions. For example, an illustrative condition for initiating retraining by the performance monitoring block 1030 may be the following: IF ((measured throughput<required throughput) OR (measured latency>required latency)) THEN trigger retraining

In some aspects, there may be multiple sets of the configured conditions. Exemplarily, a first set of conditions may be associated with minimum QoS requirements (e.g. lower bound conditions), and a second set of conditions may be associated with overprovisioning of radio resources (e.g. upper bound conditions). In such a constellation, the first set of conditions may be more aggressive to obtain a quick reaction and/or quick recovery to support the required QoS.

The block diagram 1000 further depicts an AI model training service block 1040. The AI model training service block 1040 may provide relevant services to train/retrain the GAI model based on the trigger for model training provided by the performance monitoring block 1030. As denoted, the training data generation block 1020 may provide required training data for the GAI model to be retrained. In some examples, the GAI model at a certain time-stamp may be transferred to the AI model training service block 1040 in which the GAI model may be trained/retrained with the training data provided by the training data generation block 1020. The retrained model may be transferred to the GAI model. In that sense, model transfer may be reciprocal between the AI model training service block 1040 and a GAI model block 1050.

The block diagram 1000 further depicts the GAI model block 1050. The GAI model block 1050 may refer to or include a GAI model that is a generative neural network model such as a transformer. The aim of the GAI model 1050 may be to generate a scheduling parameter including user selection, allocation of radio/spectrum resources, transmit Tx power, and the like. As denoted, the radio/spectrum resources may include time, frequency, space resources, etc., thereby achieving certain user-level and network-level performance requirements. In some examples, the GAI model 1050 may generate an appropriate output representing a schedule parameter based on the current and previous feature vectors from the input embedding block.

In some aspects, the initial training or retraining of the GAI model 1050 to generate scheduling decisions (i.e. scheduling parameter) may be a challenging task since it is difficult to produce optimum output parameter values for training labels. For a given input feature vector to the GAI model 1050, the expected optimum values of the output parameters (i.e. scheduling parameter) including user selection, resource selection, transmit Tx parameters, etc. may be unknown. Therefore, the optimization associated with a base station scheduler may suffer from dimensionality and an analytical method available to compute the output parameters may not exist.

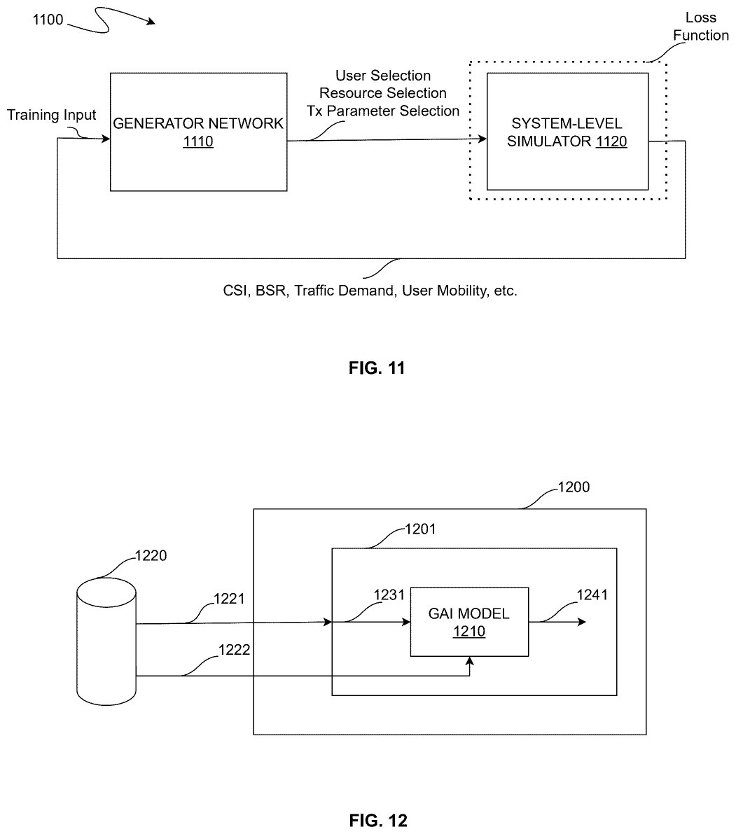

FIG. 11 shows an example of a loop-based diagram 1100, which may be referred as to a simulation-in-the-loop. The processor of the device 900 may implement aspects described herein for the loop-based diagram. A system-level simulator 1020 within the loop-based diagram 1100 may be used to generate loss values based on a loss function in which the loss values are to be used in a back-propagation algorithm during training. Based on the state of the simulation, input parameters such as CSI, BSR, traffic demand, user mobility, etc. may be extracted from the simulation and provided to input of a generative network 1110. The generative network 1110 may include different layers involving fully connected layers, convolutional layers, attention layers, etc. in order to accurately learn the optimum scheduling decision-making criteria.

In some examples, the output of generator network 1110 including scheduling parameter (i.e. scheduling decisions) such as user selection, radio resource selection (e.g. time resource, frequency, resource, etc.), transmit Tx parameter selection, and the like may be provided to the system-level simulator 1120. Based on the input parameters (i.e. scheduling parameter), the system-level simulator 1120 may generate KPI parameters including throughput, latency, and reliability of packet transmissions, etc. Such KPI parameters may be used to formulate the loss function generating loss values based on the target performance of a base station scheduler.

In accordance with various aspects of the disclosure, an architecture to use generative AI-based (GAI) models for network configuration optimization may be provided.

FIG. 12 depicts a device 1200 (i.e. apparatus) in accordance with the various aspects disclosed herein. The device 1200 may refer to a device of a network access node (e.g. network access node 110). The device 1200 may include a processor 1201 (e.g. processor 501, processor 601, processor 701, etc.). Furthermore, the device 1200 may include a transceiver in order to communicate with user devices and/or UEs within a cellular communication network. In some examples, the processor 1201 may receive data from e.g. a storage component 1220. In an example, the storage component 1220 may store historical network configuration and performance traces. Furthermore, the storage component 1220 may store UE-specific information associated with a plurality of UEs served by the network access node. In some cases, the storage component 1220 may further store network-specific information. In that sense, the storage component 1220 may refer to a storage system that takes place in the optimization and management infrastructure of the cellular communication network.

In some aspects, UE-specific information may include one or more of respective channel state indicator (CSI); a respective channel quality indicator (CQI); a respective buffer status report (BSR); a respective priority level; a respective quality of service (QoS) requirement, a respective QoS flow metric; a mobility indicator, a network traffic demand, etc. of each UE within a cellular communication network. In some aspects, the network-specific information may include one or more of a network congestion notification, an interference level, a measured UE performance metric, a measured performance metric of the cellular communication network, a latency metric, a data throughput metric, a UE perceived throughput metric, a QoS reliability metric, a packet loss rate, a QoS flow delay metric, etc.

The processor 1201 may obtain radio network access (RAN) measurements including both UE-specific information and network-specific information. In some examples, the processor 1201 may generate a token (i.e. input token) based on the UE-specific information and network-specific information denoted as time-series RAN measurements 1221 within the architecture shown in FIG. 12. Illustratively, the processor 1201 may generate the input token 1231 based on the time-series RAN measurements 1221 including UE-specific and network-specific information. In some aspects, the processor 1201 may provide the token 1231 to input of a GAI model 1210.

In some aspects, the processor 1201 may merge multiple RAN measurements associated with a UE (i.e. per UE RAN measurements) that may be available at the network access node. Such measurements may be merged into an input vector of a single time stamp, leading to a single input token. Exemplarily, such RAN measurements (i.e. per UE RAN measurements) may include Channel Quality Indicator (CQI), Channel State Information (CSI), traffic demand based on QoS-flow parameters or traffic demand estimated based on recent data volume measurements, buffer state report, per UE or per QoS flow data throughput, per UE or per QoS flow delay metric (e.g., average delay or delay histogram), per UE or per QoS flow reliability metric (e.g., packet loss rate), etc.

Notably, measurement time granularity may be different for the RAN metrics exemplified above. For example, CQI, CSI and/or BRI may be measured and/or reported around every four transmission time interval (TTI) where a single TTI equals to Ims in LTE technology. Performance metrics, on the other hand, may typically be measured at longer durations such as 100 ms. Therefore, metrics such as CQI, CSI and/or BRI may refer to more frequently reported metrics, while the performance metrics may refer to less frequently reported metrics. In some aspects, for each reporting interval of the less frequently measured/reported/updated metrics and/or measurements, there may be potential solutions to incorporate the more frequently measured/reported/updated metrics and/or measurements.

In an example, concatenation of the more frequently measured/reported/updated metrics and/or measurements during the longer report interval of the less frequently measured/reported/updated metrics and/or measurements may be performed to report all the measurements within a more lengthy feature vector. In another example, preprocessing may be performed on the more frequently measured/reported/updated metrics and/or measurements. Exemplarily, a moving average filtering may be applied or such measurements may be provided to a neural network. Consequently, the processor 1201 may provide the input token 1231 based on time-series RAN measurements to input of a GAI model 1210.

Furthermore, the processor 1201 may obtain a conditioning input 1222. The conditioning input 1222 may include network features and/or scheduling configuration. The processor 1201 may provide the conditioning parameter to input of the GAI model 1210. Therefore, the conditioning input 1222 may refer to another input for the GAI model 1210 in addition to the input token 1231. In some aspects, the processor 1201 may determine that the conditioning input includes network features. The network features may include one or more of interference level time-frequency pattern, a frequency reuse pattern of a neighboring cell, an inter-cell interference coordination pattern of a neighboring cell, or a feature based on at least one of the frequency reuse pattern or the inter-cell interference coordination pattern. The neighboring cell as disclosed may refer to or include a cell within a proximity/vicinity of a cell served by the network access node within the cellular communication network.

In some aspects, the processor 1201 may determine that the conditioning input includes scheduling configuration. The scheduling information may include one or more of a number of resource blocks to be allocated to the one or more UEs, a scheduling metric for the one or more UEs, a proportion fair (PF) metric for the one or more UEs. In some aspects, the processor 1201 may provide the input token 1231 and the conditioning input 1222 to input of the GAI model 1210. In some examples, the processor 1201 may implement the GAI model 1210 to generate an output 1241. In some aspects, the output 1241 may refer to an output with a conditioning. In some cases, the output 1241 may refer to a prediction associated with RAN performance for multiple UEs within the cellular communication network.

In accordance with various aspects disclosed herein, the GAI model 1210 may be a GAI model that is based on decoder-only transformer architecture. Such a model may be trained by leveraging self-supervised learning using performance metrics of the next token (e.g. input token) as the output label.

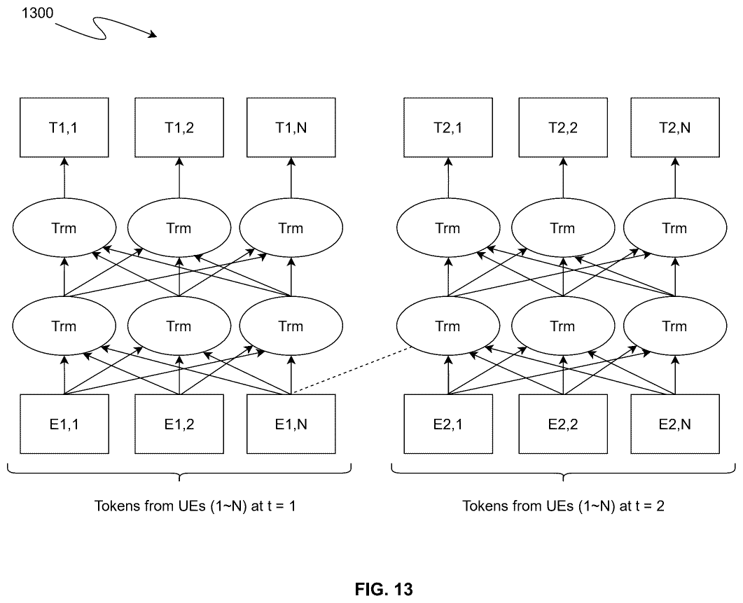

FIG. 13 shows an example of an attention architecture 1300 for a transformer (i.e. decoder-only transformer) in accordance with various aspects of the disclosure. As it is typical for a cellular communication network that a cell may include multiple UEs. The processor of the device 900 may implement aspects described herein for the attention architecture. The attention architecture 1300 may be based on a postulate that measurements received by each UE of the multiple UEs form a single token. The transformer (e.g. the GAI model 1210) may predict the performance of the next tokens (at the next time slot) for the multiple UEs. In some aspects, the transformer (e.g. the GAI model 1210) may attend only to current and past tokens from the multiple UEs. The attention architecture 1300 depicts two layers. The attention mechanism shown may include temporal casual attention where the architecture 1300 displays attention to one or more tokens associated with the next or further time slot. The attention architecture 1300 further depicts the attention across the UE.

Illustratively, the attention architecture 1300 depicts transformer layers Trm, output predictions T11, T12, T21, etc, and the input tokens E11, E12, E21, etc. Notably, the input tokens E11, E12, E21, . . . are illustrated for time instances as a first time instance t=1, and a second time instance, t=2. However, the skilled person would recognize that number of time instances may be extended to reveal input tokens at a further time point (e.g. t=T). Within the attention architecture 1300, the uninterrupted connections may refer to attention across the UE (i.e. the architecture attends only current or past tokens for a given time instance). The dashed lines, on the other hand, may demonstrate temporal attention (i.e. architecture attends future tokens temporarily).

In some aspects, a positional encoding may be applied to the input prior to passing the input into the transformer (i.e. decoder-only transformer) in order to differentiate between the impact emerged from temporal relationship (e.g. temporal attention) and the impact emerged from resource competition among UEs. In some cases, the positional encoding may account for time stamps as well as UE identifiers. Exemplarily, a sinusoidal positional encoding may be denoted as

$$PE ( t , n , d ) = \{ \begin{matrix}sin ( \frac{\hat{N} t + n}{{100000}^{\frac{2 {δ}^{′}}{d}}} ) & if δ = 2 {δ}^{′} \\ cos ( \frac{\hat{N} t + n}{{100000}^{\frac{2 {δ}^{′}}{d}}} ) & if δ = 2 {δ}^{′} + 1\end{matrix}$$

Where N\hat{ } is the maximum number of UEs a network access node (e.g. base station) can serve (N\hat{ }((t))≤N\hat{ },∀t).

Referring back to FIG. 12, there may be a variety of options that can be leveraged in order to introduce the conditioning input 1222 within an input data for the decoder-only transformer (e.g. GAI model 1210). In some examples, the processor 1201 may provide the conditioning input 1222 into a neural network, such as a multi-layer perceptron (MLP) network. In such a case, the MLP network may output scaling and/or shifting factors for adjusting intermediate outputs within the decoder-only transformer architecture by passing through cross-attention layers inserted between self-attention layers, or by concatenating the conditioning input 1222 with a received input data (e.g. input 1211) to obtain the input data.

In some aspects, GAI model 1210 may determine the output that it generates based on a performance metric. Exemplarily, the GAI model 1210 may be provided with the input data (e.g. input token 1231 based on network-specific and UE-specific information and/or the conditioning input 1222). In some aspects, the GAI model 1210 may calculate a score for multiple outputs based on the input data may determine an output based on the calculated scores. In that way, the GAI modes 1210 may determine a scheduling parameter based on a score comparison among candidate scheduling parameters.

In some examples, GAI model 1210 may serve as a reward model for training a scheduler policy agent via reinforcement learning. In such a constellation, the GAI model 1210 may predict a RAN performance parameter at a first instance of time (e.g. time to). Accordingly, GAI model 1210 may determine a reward for an action taken at the same time instance (e.g. time to) in which the action is taken by the scheduler policy agent.

Still referring to FIG. 12, GAI model 1210 may generate a scheduling parameter further based on received sensing data features. Although a typical base station scheduler may generate the scheduling parameter based on input data like UE-specific information and network-specific information. GAI model 1210 may take features based on sensing data as additional input that can be included in the input data. Sensing data features may be received from output of respective GAI models, or output of a data fusion network. As denoted, sensing data features may include information about the monitored environment surrounding the network access node. Sensing data features used as additional input to reinforce the input data may enable the GAI model 1210 to generate a more optimized scheduling parameter.

In some examples, in addition to UE-specific information and network-specific information from which the processor 1201 may generate the input token 1221, sensing data may also be included. In such a case, the processor 1201 may generate an input token based on the UE-specific information, network-specific information as well as the sensing data. Sensor data may exemplarily include a spectrum map based on data retrieved from a spectrum sensor, raw data and metadata from a spectrum sensor, or other sensor (e.g. camera images). In some aspects, the device 1200 may include the sensor or the sensor node providing the sensor data.

In some examples, a device of a network access node (e.g. the device 1200) may generate features via corresponding GAI models in which the features are based on sensor data and network measurements. For example, the device including a processor (e.g. processor 501, 601, 701, 1201, etc.) that receives camera sensor data, Lidar sensor data, and network measurements available at the network access node may provide these data to corresponding GAI models. In that sense, the network access node may be regarded as a sensor node, and the corresponding network measurements may be regarded as additional sensor data associated with a modality different from the modalities associated with both the camera sensor and Lidar sensor. Therefore, the processor may provide each type of data to input of a corresponding model. Such a scheme may require an additional trained GAI model apart from GAI models trained to process and generate corresponding features from camera sensor data and Lidar sensor data (e.g. GC 710A, GL 720A). Such a GAI model may be trained leveraging the training scheme depicted in FIG. 8

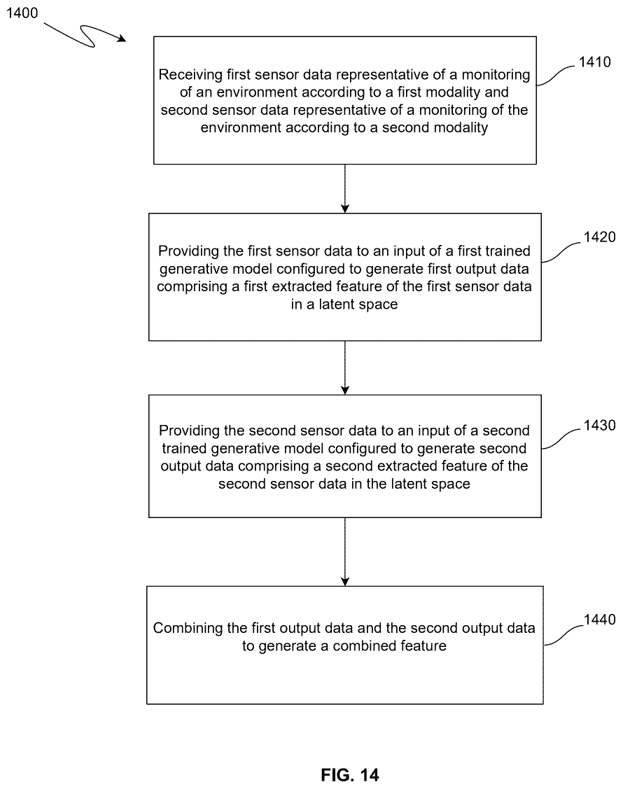

FIG. 14 shows a method 1400 in accordance with various aspects of the disclosure. The method 1400 may include, at block 1410, receiving first sensor data representative of a monitoring of an environment according to a first modality and second sensor data representative of a monitoring of the environment according to a second modality. The method 1400 may further include, at block 1420, providing the first sensor data to an input of a first trained generative model configured to generate first output data comprising a first extracted feature of the first sensor data in a latent space.

The method 1400 may include, at block 1430, providing the second sensor data to an input of a second trained generative model configured to generate second output data comprising a second extracted feature of the second sensor data in the latent space. The method 1400 may include, at block 1440, combining the first output data and the second output data to generate a combined feature.

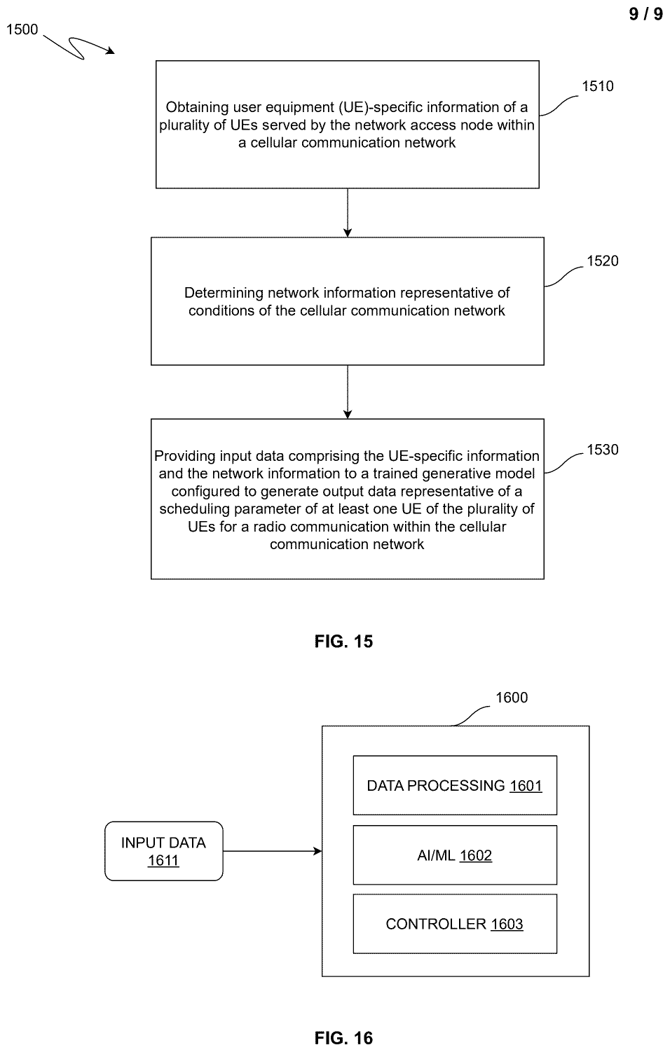

FIG. 15 shows a method in accordance with various aspects of the disclosure. The method 1500 may include, at block 1510, obtaining user equipment (UE)-specific information of a plurality of UEs served by the network access node within a cellular communication network. The method 1500 may further include, at block 1520, determining network information representative of conditions of the cellular communication network. The method 1500 may include, at block 1530, providing input data comprising the UE-specific information and the network information to a trained generative model configured to generate output data representative of a scheduling parameter of at least one UE of the plurality of UEs for a radio communication within the cellular communication network.

### AI/ML

FIG. 16 shows schematically an example of a processor to implement an AI/ML (e.g. a GAI model) in accordance with various aspects provided herein. The processor 1600 is depicted to include various functional units that are configured to provide various functions as disclosed herein, associated with the processors 501, 601, 701, 901, 1201, etc. The skilled person would recognize that the depicted functional units are provided to explain various operations that the processor 1600 may be configured to perform.

Furthermore, the AI/ML unit 1602 is depicted as it is implemented in the processor 1600 only as an example, and any type of AI/ML implementation which may include the implementation of the AI/ML in an external processor, such as an accelerator, a graphics processing unit (GPU), a neuromorphic chip, or in a cloud computing device, or in an external processing device may also be possible according to any methods.

The processor 1600 may include a data processing unit 1601 that is configured to process data and obtain input of the AI/ML unit based on the input data 1611 (e.g. sensor data) as provided in various examples in this disclosure. In various examples, the input data 1611 may include data of not only current but also past information for at least within a period of time in a plurality of instances of time (e.g. as a time-series data).

The data processing unit 1601 may implement various preprocessing operations to obtain the input. Such operations may include cleaning the input data 1611 by removing outliers, handling of missing parameters, correcting errors or inconsistencies, and such. Operations may further include data normalizations in order to scale the input data 1611 to a common range. Operations may further include data transformation including mapping the input data 1611 based on predefined mapping operations corresponding to mathematical functions to map one or more data items of the input data 1611 to a mapped data time for the purpose of analysis.

The data processing unit 1601 may be configured to generate training dataset based on the input data 1611. In other words, based output of the AI/ML unit 1602 in response to the input of the AI/ML, the data processing unit 1601 may prepare the training data to be used in the training of the AI/ML The data processing unit 1601 may be configured to apply data fusion techniques to aggregate data. Data fusion may be considered as a process of integrating and combining data, within this context, by combining the input data 1611 to obtain a unified dataset.

The data processing unit 1601 may further implement feature extraction operations. It is to be considered that the AI/ML implemented by the AI/ML unit may have certain constraints, some of which may relate to the structure and aspects of the data to be inputted to the AI/ML. The feature extraction operations may include translating (i.e. transforming) the input data 1611 into input of the AI/ML. The feature extraction operations may further include generation of training input data for the training dataset based on the input data 1611. In some aspects, the feature extraction operations may be based on model information representing the attributes to be used as the input of the AI/ML, relative importance or weights of the attributes, etc. The feature extraction operations may include reducing the number of attributes (i.e. data items from the input data 1611) to be used, ranking of the attributes, etc. based on the model information.

In some aspects, the input data 1611 may include information representative of annotations and/or labels to be used for training. In some aspects, the data processing unit 1601 may also assign labels or assign ground truth values for the generated training data for the generation of the training dataset. In some aspects, the data processing unit 1601 may further generate annotations for the generation of the training data set. Generation of annotations and/or labels may be according to supervised training inputs, or may be based on unsupervised methods, exemplarily by an implementation of an automatized model to assign the labels and/or the annotations.

For supervised learning, generation of labels and annotations may require domain expertise and an understanding of the specific tasks that the AI/ML is designed to address. For example, a human expert might need to review network logs and performance data to identify contributions to communication resource efficiency, which could then be labeled as positive or negative examples for a congestion prediction model. In some cases, semi-supervised or unsupervised learning techniques can be used to reduce the reliance on labeled data. These approaches may involve clustering, anomaly detection, or other methods that can identify patterns and relationships in the data without explicit ground truth labels.

Accordingly, the data processing unit 1601 may generate the training dataset based on the input data 1611. It is to be noted that the AI/ML unit 1602 may use the training dataset in predefined portions, namely a first portion of the training data set for training, a second portion of the training dataset for validation and a third portion of the training dataset for testing purposes. The AI/ML unit 1602 may use the first portion to train the AI/ML, which may allow the AI/ML to learn the underlying patterns and relationships in the data. The AI/ML unit 1602 may use the second portion to evaluate and fine-tune the AI/ML during the training process, which may help to prevent overfitting and improve generalization. Finally, the AI/ML unit 1602 may use the third portion to assess the performance of the trained AI/ML and provide an unbiased estimate of their accuracy and effectiveness for AI/ML tasks.

The AI/ML unit 1602 may implement one or more AI/MLs. The aspects are provided for one AI/ML but it may also include applications involving more than one AI/MLs. The AI/ML may be configured to receive the input with certain constraints, features, and formats. Accordingly, the data processing unit 1601 may obtain the input of the AI/ML, that is based on the input data 1611, to be provided to the AI/ML to obtain an output of the AI/ML. In various examples, the data processing unit 1601 may provide input data including the input data 1611 to the AI/ML. The input of the AI/ML may include attributes of the input data 1611 associated with a period of time or a plurality of consecutive periods of time. In various examples, the data processing unit 1601 may convert the input data 1611 to an input format suitable for the AI/ML (i.e. feature extraction e.g. to input feature vectors) so that the AI/ML may process the input data 1611. It is to be noted that the input of the AI/ML may naturally include data, though the term input of the AI/ML has been used to distinguish from the term “input data”.

The processor 1600 may further include a controller 1603 to control the AI/ML unit 1602. The controller 1603 may provide the input to the AI/ML, or provide the AI/ML unit 1602 instructions to obtain the output. The controller 1603 may further be configured to perform further operations of the processor 1600 in accordance with various aspects of this disclosure.

The AI/ML may be any type of machine learning model configured to receive the input of the AI/ML and provide an output as provided in this disclosure. The AI/ML may stand for the ML-based application provided in the disclosure. The AI/ML may include any type of machine learning model suitable for the purpose. The AI/ML may include a decision tree model or a rule-based model suitable for various aspects provided herein. The AI/ML may include a neural network. The neural network may be any type of artificial neural network. The neural network may include any number of layers, including an input layer to receive the input of the AI/ML, an output layer to provide the output data. A number of layers may be provided between the input layer and the output layer (e.g. hidden layers). The training of the neural network (e.g., adapting the layers of the neural network, adjusting Model parameters) may use or may be based on any kind of training principle, such as backpropagation (e.g., using the backpropagation algorithm).

For example, the neural network may be a feed-forward neural network in which the information is transferred from lower layers of the neural network close to the input to higher layers of the neural network close to the output. Each layer may include neurons that receive input from a previous layer and provide an output to a next layer based on certain AI/ML (e.g. weights) parameters adjusting the input information.

The AI/ML may include a recurrent neural network in which neurons transfer the information in a configuration in which the neurons may transfer the input information to a neuron of the same layer. Recurrent neural networks (RNNs) may help to identify patterns between a plurality of input sequences, and accordingly, RNNs may be used to identify, in particular, a temporal pattern provided with time-series data and perform estimations based on the identified temporal patterns. In various examples of RNNs, long short-term memory (LSTM) architecture may be implemented. The LSTM networks may be helpful to perform classifications, processing, and estimations using time series data.

An LSTM network may include a network of LSTM cells that may process the attributes provided for an instance of time as input of the AI/ML, such as attributes provided for the instance of time, and one or more previous outputs of the LSTM that have taken in place in previous instances of time, and accordingly, obtain the output data. The number of the one or more previous inputs may be defined by a window size, and the weights associated with each previous input may be configured separately. The window size may be arranged according to the processing, memory, and time constraints and the input of the AI/ML. The LSTM network may process the features of the received raw data and determine a label for an attribute for each instance of time according to the features. The output data may include or represent a label associated with the input of the AI/ML.

In various examples, the neural network may be configured in top-down configuration in which a neuron of a layer provides output to a neuron of a lower layer, which may help to discriminate certain features of an input.

In accordance with various aspects, the AI/ML may include a reinforcement learning model. The reinforcement learning model may be modeled as a Markov decision process (MDP). The MDP may determine an action from an action set based on a previous observation which may be referred to as a state. In a next state, the MDP may determine a reward based on the current state that may be based on current observations and the previous observations associated with previous state. The determined action may influence the probability of the MDP to move into the next state. Accordingly, the MDP may obtain a function that maps the current state to an action to be determined with the purpose of maximizing the rewards. Accordingly, input of the AI/ML for a reinforcement learning model may include information representing a state, and an output data may include information representing an action.

Reinforcement learning (RL) is a type of machine learning that focuses on training an agent to make decisions by interacting with an environment. The agent learns to perform actions to achieve a goal by receiving feedback in the form of rewards or penalties. As a machine learning model, reinforcement learning models learn from data (in this case, the agent's experiences and interactions with the environment) to adapt their behavior and improve their performance over time. Since machine learning is a subset of AI, reinforcement learning models are also considered AI models, as they aim to perform tasks that require human-like decision-making capabilities.

The AI/ML may include a convolutional neural network (CNN), which is an example for feed-forward neural networks that may be used for the purpose of this disclosure, in which one or more of the hidden layers of the neural network include one or more convolutional layers that perform convolutions for their received input from a lower layer. The CNNs may be helpful for pattern recognition and classification operations. The CNN may further include pooling layers, fully connected layers, and normalization layers.

The AI/ML may include a generative neural network. The generative neural network may process input of the AI/ML in order to generate new sets, hence the output data may include new sets of data according to the purpose of the AI/ML. In various examples, the AI/ML may include a generative adversarial network (GAN) model in which a discrimination function is included with the generation function, and while the generation function may generate the data according to model parameters of the generation function and the input of the AI/ML, the discrimination function may distinguish the data generated by the generation function in terms of data distribution according to model parameters of the discrimination function. In accordance with various aspects of this disclosure, a GAN may include a deconvolutional neural network for the generation function and a CNN for the discrimination function. The AI/ML may include a trained AI/ML that is configured to provide the output as provided in various examples in this disclosure based on the input of the AI/ML and one or more Model parameters obtained by the training. The trained AI/ML may be obtained via an online and/or offline training. A training agent may perform various operations with respect to the training at various aspects, including online training, offline training, and optimizations based on the inference results. The AI/ML may take any suitable form or utilize any suitable technique for training process. For example, the AI/ML may be trained using supervised learning, semi-supervised learning, unsupervised learning, or reinforcement learning techniques.

In supervised learning, the AI/ML may be obtained using a training dataset including both inputs and corresponding desired outputs (illustratively, input data may be associated with a desired or expected output for that input data). Each training instance may include one or more input data item and a desired output. The training agent may train the AI/ML based on iterations through training instances and using an objective function to teach the AI/ML to estimate the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training dataset including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive feedback (also referred to as reward) or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

The training agent may adjust the Model parameters of the respective model based on outputs and inputs (i.e. output data and input data). The training agent may train the AI/ML according to the desired outcome. The training agent may provide the training data to the AI/ML to train the AI/ML. In various examples, the processor and/or the AI/ML unit itself may include the training agent, or another entity that may be communicatively coupled to the processor may include the training agent and provide the training data to the device, so that the processor may train the AI/ML.

In various examples, the device may include the AI/ML in a configuration that it is already trained (e.g. the Model parameters in a memory are already set for the purpose). It may be desirable for the AI/ML itself to have the training agent, or a portion of the training agent, in order to perform optimizations according to the output of inferences as provided in this disclosure. The AI/ML may include an execution unit and a training unit that may implement the training agent as provided in this disclosure for other examples. In accordance with various examples, the training agent may train the AI/ML based on a simulated environment that is controlled by the training agent according to similar considerations and constraints of the deployment environment.

The skilled person would immediately recognize that the exemplary AI/ML disclosed herein is explained that may have many configurations. In a least complex scenario, for execution of the AI/ML (i.e. inference), the AI/ML may be configured to provide an output including a predicted network usage pattern of the communication device 1100. For training of the AI/ML, the training agent may train the AI/ML by providing training input data of the generated training dataset to the input of the AI/ML and it may adjust model parameters of the AI/ML based on the output of the AI/ML that is mapped according to the training input data, and training output data of the training dataset (e.g. labels, annotations) associated with the provided training input data with an intention to make the output of the AI/ML more accurate. Accordingly, the training agent may adjust one or more model parameters based on a calculation including parameters for the output of the AI/ML for the training input data and the training output data associated with the training input data. In various examples, the calculation may also include one or more parameters of the AI/ML. With each iteration with respect to the training input data that may include many data items, which each data item may represent an input of an instance (of time, of observation, etc.) on various aspects and each iteration may iterate a respective data item representing an input of an instance, the training agent may accordingly cause the AI/ML to provide more accurate output through adjustments made in the model parameters.

The processor 1600 may implement the training agent, or another entity that may be communicatively coupled to the processor 1600 may include the training agent and provide the training input data to the device, so that the processor 1600 may train the AI/ML. The training agent may be part of the AI/ML unit 1602 described herein. Furthermore, the controller 1603 may control the AI/ML unit 1602 according to a predefined event. For example, the controller 1603 may provide instructions to the AI/ML unit 1602 to perform the inference and/or training in response to a received request from another entity. The controller 1603 may further obtain output of the AI/ML from the AI/ML unit 1602.

### Examples

In example 1A, the subject matter includes an apparatus including: an interface configured to receive first sensor data representative of a monitoring of an environment according to a first modality and second sensor data representative of a monitoring of the environment according to a second modality; and a processor configured to: provide the first sensor data to an input of a first trained generative model configured to generate first output data including a first extracted feature of the first sensor data in a latent space; provide the second sensor data to an input of a second trained generative model configured to generate second output data including a second extracted feature of the second sensor data in the latent space; and combine the first output data and the second output data to generate a combined feature.

In example 2A, the subject matter of example 1A, wherein the combined feature is representative of a feature of the environment determined based on the first modality and the second modality.

In example 3A, the subject matter of example 1A or example 2A, wherein the processor is further configured to encode the combined feature for a transmission to a further communication device.

In example 4A, the subject matter of any one of examples 1A to 3A, wherein the combined feature is in the latent space and used as an input of a further data fusion network for a hierarchical combining to obtain a further feature.

In example 5A, the subject matter of any one of examples 1A to 4A, wherein the processor is further configured to: decode feature information representative of a further feature in the latent space, wherein the feature information is received from another communication device and representative of a monitoring of a further environment associated with the another communication device; and combine the first output data, the second output data, and the further feature to generate the combined feature.

In example 6A, the subject matter of any one of examples 4A to 5A, wherein the processor is further configured to: decode further sensor data received from a further communication device and representative of a monitoring of an environment associated with the further feature; provide the further sensor data to an input of a third generative model configured to generate third output data including at least one extracted feature of the further sensor data in the latent space; and combine the first output data, the second output data, and the third output data to generate the combined feature.

In example 7A, the subject matter of example 6A, wherein the environment associated with the further communication device and the environment are the same environment; and wherein the further sensor data represents the environment based on a modality that is different from the first modality and/or the second modality.

In example 8A, the subject matter of any one of examples 1A to 7A, wherein the processor is further configured to: decode network data received from a further network device and representative of measurements of a network in which the further network device operates; provide the network data to an input of a further generative model configured to generate further output data including at least one extracted feature of the further sensor data in the latent space; and combine the first output data, the second output data, and the further output data to generate the combined feature.

In example 9A, the subject matter of any one of examples 1A to 8A, wherein the first output data and the second output data includes respective feature vectors, each feature vector having an equal number of data items; and wherein the first trained generative model and the second trained generative model are trained together with a common end-to-end loss.

In example 10A, the subject matter of any one of examples 1A to 9A, wherein the first trained generative model is configured to generate the first output data based on first weight parameters of the first trained generative network the second trained generative model is configured to generate the second output data based on second weight parameters of the second trained generative network; and wherein the first trained generative model and the second generative model are trained such that the first weight parameters of the first trained generative model and the second weight parameters of the second trained generative model includes shared parameters.

In example 11A, the subject matter of any one of examples 1A to 10A, wherein the processor is further configured to implement a trained fusion network model to generate the combined feature in the latent space.

In example 12A, the subject matter of example 11A, wherein the trained fusion network model is trained by configuring a fusion network model to provide its respective output data as an input of a copy of the fusion network model; and wherein the fusion network model and the copy of the fusion network model are configured to generate their respective output data based on respective weight parameter including common weight parameters.

In example 13A, the subject matter of any one of examples 1A to 12A, wherein the processor is further configured to provide information representative of the combined feature to an object detection network.

In example 14A, the subject matter of any one of examples 1A to 13A, may further include: a first sensor of a first type, the first sensor configured to monitor the environment according to the first modality; and a second sensor of a second type, the second sensor configured to monitor the environment according to the second modality.

In example 15A, the subject matter of any one of examples 1A to 14A, may further include: a transceiver configured to cause the apparatus to communicate with one or more further communication devices.

In example 16A, A method including: receiving first sensor data representative of a monitoring of an environment according to a first modality and second sensor data representative of a monitoring of the environment according to a second modality; providing the first sensor data to an input of a first trained generative model configured to generate first output data including a first extracted feature of the first sensor data in a latent space; providing the second sensor data to an input of a second trained generative model configured to generate second output data including a second extracted feature of the second sensor data in the latent space; and combining the first output data and the second output data to generate a combined feature.

In example 17A, the subject matter of example 16A, wherein the combined feature is representative of a feature of the environment determined based on the first modality and the second modality.

In example 18A, the subject matter of example 16A or example 17A, may further include: encoding the combined feature for a transmission to a further communication device.

In example 19A, the subject matter of any one of examples 16A to 18A, wherein the combined feature is in the latent space and used as an input of a further data fusion network for a hierarchical combining to obtain a further feature.

In example 20A, the subject matter of any one of examples 16A to 19A, may further include: decoding feature information representative of a further feature in the latent space, wherein the feature information is received from another communication device and representative of a monitoring of a further environment associated with the another communication device; and combining the first output data, the second output data, and the further feature to generate the combined feature.

In example 21A, the subject matter of any one of examples 16A to 20A, may further include: decoding further sensor data received from a further communication device and representative of a monitoring of an environment associated with the further communication device; providing the further sensor data to an input of a third generative model configured to generate third output data including at least one extracted feature of the further sensor data in the latent space; and combining the first output data, the second output data, and the third output data to generate the combined feature.

In example 22A, the subject matter of example 21A, wherein the environment associated with the further communication device and the environment are the same environment; and wherein the further sensor data represents the environment based on a modality that is different from the first modality and/or the second modality.

In example 23A, the subject matter of any one of examples 16A to 22A, may further include: decoding network data received from a further network device and representative of measurements of a network in which the further network device operates; providing the network data to an input of a further generative model configured to generate further output data including at least one extracted feature of the further sensor data in the latent space; and combining the first output data, the second output data, and the further output data to generate the combined feature.

In example 24A, the subject matter of any one of examples 16A to 23A, wherein the first output data and the second output data includes respective feature vectors, each feature vector having an equal number of data items; and wherein the first trained generative model and the second trained generative model are trained together with a common end-to-end loss.

In example 25A, the subject matter of any one of examples 16A to 24A, wherein the first trained generative model is configured to generate the first output data based on first weight parameters of the first trained generative network the second trained generative model is configured to generate the second output data based on second weight parameters of the second trained generative network; and wherein the first trained generative model and the second generative model are trained such that the first weight parameters of the first trained generative model and the second weight parameters of the second trained generative model includes shared parameters.

In example 26A, the subject matter of any one of examples 16A to 25A, may further include: implementing a trained fusion network model to generate the combined feature in the latent space.

In example 27A, the subject matter of example 26A, wherein the trained fusion network model is trained by configuring a fusion network model to provide its respective output data as an input of a copy of the fusion network model; and wherein the fusion network model and the copy of the fusion network model are configured to generate their respective output data based on respective weight parameter including common weight parameters.

In example 28A, the subject matter of any one of examples 16A to 27A, may further include: providing information representative of the combined feature to an object detection network.

In example 29A, the subject matter includes a non-transitory computer-readable medium including instructions which, if executed by a processor, cause the processor to: control an interface configured to receive first sensor data representative of a monitoring of an environment according to a first modality and second sensor data representative of a monitoring of the environment according to a second modality; provide the first sensor data to an input of a first trained generative model configured to generate first output data including a first extracted feature of the first sensor data in a latent space; provide the second sensor data to an input of a second trained generative model configured to generate second output data including a second extracted feature of the second sensor data in the latent space; and combine the first output data and the second output data to generate a combined feature.

In example 30A, the subject matter of example 29A, wherein the combined feature is representative of a feature of the environment determined based on the first modality and the second modality.

In example 31A, the subject matter of example 29A or example 30A, wherein the instructions further cause the processor to encode the combined feature for a transmission to a further communication device.

In example 32A, the subject matter of any one of examples 29A to 31A, wherein the combined feature is in the latent space and used as an input of a further data fusion network for a hierarchical combining to obtain a further feature.

In example 33A, the subject matter of any one of examples 29A to 32A, wherein the instructions further cause the processor to: decode feature information representative of a further feature in the latent space, wherein the feature information is received from another communication device and representative of a monitoring of a further environment associated with the another communication device; and combine the first output data, the second output data, and the further feature to generate the combined feature.

In example 34A, the subject matter of any one of examples 29A to 33A, wherein the instructions further cause the processor to: decode further sensor data received from a further communication device and representative of a monitoring of an environment associated with the further communication device; provide the further sensor data to an input of a third generative model configured to generate third output data including at least one extracted feature of the further sensor data in the latent space; and combine the first output data, the second output data, and the third output data to generate the combined feature.

In example 35A, the subject matter of example 29A, wherein the environment associated with the further communication device and the environment are the same environment; and wherein the further sensor data represents the environment based on a modality that is different from the first modality and/or the second modality.

In example 36A, the subject matter of any one of examples 29A to 35A, wherein the instructions further cause the processor to: decode network data received from a further network device and representative of measurements of a network in which the further network device operates; provide the network data to an input of a further generative model configured to generate further output data including at least one extracted feature of the further sensor data in the latent space; and combine the first output data, the second output data, and the further output data to generate the combined feature.

In example 37A, the subject matter of any one of examples 29A to 36A, wherein the first output data and the second output data includes respective feature vectors, each feature vector having an equal number of data items; and wherein the first trained generative model and the second trained generative model are trained together with a common end-to-end loss.

In example 38A, the subject matter of any one of examples 29A to 37A, wherein the first trained generative model is configured to generate the first output data based on first weight parameters of the first trained generative network the second trained generative model is configured to generate the second output data based on second weight parameters of the second trained generative network; and wherein the first trained generative model and the second generative model are trained such that the first weight parameters of the first trained generative model and the second weight parameters of the second trained generative model includes shared parameters.

In example 39A, the subject matter of any one of examples 29A to 38A, wherein the instructions further cause the processor to implement a trained fusion network model to generate the combined feature in the latent space.

In example 40A, the subject matter of example 39A, wherein the trained fusion network model is trained by configuring a fusion network model to provide its respective output data as an input of a copy of the fusion network model; and wherein the fusion network model and the copy of the fusion network model are configured to generate their respective output data based on respective weight parameter including common weight parameters.

In example 41A, the subject matter of any one of examples 29A to 40A, wherein the instructions further cause the processor to provide information representative of the combined feature to an object detection network.

In example 1B, the subject matter includes an apparatus of a network access node, the apparatus including: a processor configured to: obtain user equipment (UE)-specific information of a plurality of UEs served by the network access node within a cellular communication network; determine network information representative of conditions of the cellular communication network; and provide input data including the UE-specific information and the network information to a trained generative model configured to generate output data representative of a scheduling parameter of at least one UE of the plurality of UEs for a radio communication within the cellular communication network.

In example 2B, the subject matter of example 1B, wherein the processor is further configured to generate a token for the trained generative model based on the UE-specific information and the network information; and wherein the input data is the token.

In example 3B, the subject matter of example 1B or example 2B, wherein the scheduling parameter includes information representing at least one of: a UE selection among the plurality of UEs, a time resource for the radio communication, a frequency resource for the radio communication, or a predicted radio access network performance parameter.

In example 4B, the subject matter of any one of examples 1B to 3B, wherein the UE-specific information includes information representing, for each UE of the plurality of UEs, at least one of a respective channel state indicator (CSI); a respective channel quality indicator (CQI); a respective buffer status report (BSR); a respective priority level; a respective quality of service (QoS) requirement, a respective QoS flow metric; a mobility indicator, a network traffic demand.

In example 5B, the subject matter of any one of examples 1B to 4B, wherein the network information includes information representing at least one of a network congestion notification, an interference level, a measured UE performance metric, a measured performance metric of the cellular communication network, a latency metric, a data throughput metric, a UE perceived throughput metric, a QoS reliability metric, a packet loss rate, a QoS flow delay metric.

In example 6B, the subject matter of any one of examples 1B to 5B, wherein the input data includes time-series data including radio access network measurements of the cellular communication network; and wherein the trained generative model is configured to generate the output data with a conditioning that is based on a scheduling configuration or a network feature associated with the cellular communication network.

In example 7B, the subject matter of example 6B, wherein the trained generative model is further configured to receive a conditioning input data representative of the at least one of the scheduling configuration or the network feature; and wherein the processor is further configured to determine the conditioning input data to condition the trained generative network.

In example 8B, the subject matter of example 7B, wherein the processor is further configured to determine the network feature including at least one of an interference level time frequency pattern, a frequency reuse pattern of a neighboring cell, an inter-cell interference coordination pattern of a neighboring cell, or a feature based on at least one of the frequency reuse patter or the inter-cell interference coordination pattern; and wherein the neighboring cell is a cell within a proximity of a cell served by the network access node.

In example 9B, the subject matter of example 7B or example 8B, wherein the processor is further configured to determine the output data for one or more UEs of the plurality of UEs; and wherein the processor is further configured to determine the scheduling configuration including at least one of a number of resource blocks to be allocated to the one or more UEs, a scheduling metric for the one or more UEs, a proportion fair (PF) metric for the one or more UEs.

In example 10B, the subject matter of any one of examples 7B to 9b, wherein the trained generative model is based on a decoder only transformer architecture configured to operate with a next token prediction mechanism; wherein the trained generative model is configured to predict a radio access network performance parameter for the plurality of UEs based on the input data; and wherein the input data is applied with a positioning encoding before being passed into the decoder only transformer architecture.

In example 11B, the subject matter of example 10B, wherein the processor is further configured to: obtain a determined conditioning input data; and provide the determined conditioning input data to an input of a multi-layer perceptron network configured to calculate scaling and shifting factors for adjusting intermediate outputs within the decoder only transformer architecture, by passing through cross-attention layers inserted between self-attentions layers, or by concatenating the conditioning input data with a received input data to obtain the input data.

In example 12B, the subject matter of any one of examples 1B to 11B, wherein the trained generative model is configured to determine the output data to be generated by calculating scores for a plurality of output candidates and selecting one of the plurality of output candidates based on their respective scores.

In example 13B, the subject matter of any one of examples 1B to 11B, wherein the trained generative model is configured to serve as a reward model for training a scheduler policy agent via reinforcement learning, in which the trained generative model predicts the radio access network performance parameter at a first instance of time and determine a reward for an action taken by the scheduler policy agent for the first instance of time.

In example 14B, the subject matter of any one of examples 1B to 13B, wherein the processor is further configured to schedule a communication resource to communicate with the plurality of UEs based on the output data; and wherein the processor is further configured to encode information indicating the communication resource for a transmission to at least one UE of the plurality of UEs.

In example 15B, the subject matter of any one of examples 1B to 14B, may further include a transceiver configured to communicate with the plurality of UEs.

In example 16B, the subject matter includes a method including: obtaining user equipment (UE)-specific information of a plurality of UEs served by the network access node within a cellular communication network; determining network information representative of conditions of the cellular communication network; and providing input data including the UE-specific information and the network information to a trained generative model configured to generate output data representative of a scheduling parameter of at least one UE of the plurality of UEs for a radio communication within the cellular communication network.

In example 17B, the subject matter of example 16B, may further include: generating a token for the trained generative model based on the UE-specific information and the network information; and wherein the input data is the token.

In example 18B, the subject matter of example 16B or example 17B, wherein the scheduling parameter includes information representing at least one of: a UE selection among the plurality of UEs, a time resource for the radio communication, a frequency resource for the radio communication, or a predicted radio access network performance parameter.

In example 19B, the subject matter of any one of examples 16B to 18B, wherein the UE-specific information includes information representing, for each UE of the plurality of UEs, at least one of a respective channel state indicator (CSI); a respective channel quality indicator (CQI); a respective buffer status report (BSR); a respective priority level; a respective quality of service (QoS) requirement, a respective QoS flow metric; a mobility indicator, a network traffic demand.

In example 20B, the subject matter of any one of examples 16B to 19B, wherein the network information includes information representing at least one of a network congestion notification, an interference level, a measured UE performance metric, a measured performance metric of the cellular communication network, a latency metric, a data throughput metric, a UE perceived throughput metric, a QoS reliability metric, a packet loss rate, a QoS flow delay metric.

In example 21B, the subject matter of any one of examples 16B to 20B, wherein the input data includes time-series data including radio access network measurements of the cellular communication network; and wherein the trained generative model is configured to generate the output data with a conditioning that is based on a scheduling configuration or a network feature associated with the cellular communication network.

In example 22B, the subject matter of example 21B, wherein the trained generative model is further configured to receive a conditioning input data representative of the at least one of the scheduling configuration or the network feature; and wherein the method further includes: determining the conditioning input data to condition the trained generative network.

In example 23B, the subject matter of example 22B, may further include: determining the network feature including at least one of an interference level time frequency pattern, a frequency reuse pattern of a neighboring cell, an inter-cell interference coordination pattern of a neighboring cell, or a feature based on at least one of the frequency reuse patter or the inter-cell interference coordination pattern; and wherein the neighboring cell is a cell within a proximity of a cell served by the network access node.

In example 24B, the subject matter of example 22B or example 23B, may further include: determining the output data for one or more UEs of the plurality of UEs; and determining the scheduling configuration including at least one of a number of resource blocks to be allocated to the one or more UEs, a scheduling metric for the one or more UEs, a proportion fair (PF) metric for the one or more UEs.

In example 25B, the subject matter of any one of examples 22B to 24B, wherein the trained generative model is based on a decoder only transformer architecture configured to operate with a next token prediction mechanism; wherein the trained generative model is configured to predict a radio access network performance parameter for the plurality of UEs based on the input data; and wherein the input data is applied with a positioning encoding before being passed into the decoder only transformer architecture.

In example 26B, the subject matter of example 25B, may further include: obtaining a determined conditioning input data; and providing the determined conditioning input data to an input of a multi-layer perceptron network configured to calculate scaling and shifting factors for adjusting intermediate outputs within the decoder only transformer architecture, by passing through cross-attention layers inserted between self-attentions layers, or by concatenating the conditioning input data with a received input data to obtain the input data.

In example 27B, the subject matter of any one of examples 16B to 26B, wherein the trained generative model is configured to determine the output data to be generated by calculating scores for a plurality of output candidates and selecting one of the plurality of output candidates based on their respective scores.

In example 28B, the subject matter of any one of examples 16B to 27B, wherein the trained generative model is configured to serve as a reward model for training a scheduler policy agent via reinforcement learning, in which the trained generative model predicts the radio access network performance parameter at a first instance of time and determine a reward for an action taken by the scheduler policy agent for the first instance of time.

In example 29B, the subject matter of any one of examples 16B to 28B, may further include: scheduling a communication resource to communicate with the plurality of UEs based on the output data; and encoding information indicating the communication resource for a transmission to at least one UE of the plurality of UEs.

In example 30B, the subject matter includes a non-transitory computer-readable medium including instructions which, if executed by a processor, cause the processor to: obtain user equipment (UE)-specific information of a plurality of UEs served by the network access node within a cellular communication network; determine network information representative of conditions of the cellular communication network; and provide input data including the UE-specific information and the network information to a trained generative model configured to generate output data representative of a scheduling parameter of at least one UE of the plurality of UEs for a radio communication within the cellular communication network.

In example 31B, the subject matter of example 30B, wherein the instructions further cause the processor to generate a token for the trained generative model based on the UE-specific information and the network information; and wherein the input data is the token.

In example 32B, the subject matter of example 30B or example 31B, wherein the scheduling parameter includes information representing at least one of: a UE selection among the plurality of UEs, a time resource for the radio communication, a frequency resource for the radio communication, or a predicted radio access network performance parameter.

In example 33B, the subject matter of any one of examples 30B to 32B, wherein the UE-specific information includes information representing, for each UE of the plurality of UEs, at least one of a respective channel state indicator (CSI); a respective channel quality indicator (CQI); a respective buffer status report (BSR); a respective priority level; a respective quality of service (QoS) requirement, a respective QoS flow metric; a mobility indicator, a network traffic demand.

In example 34B, the subject matter of any one of examples 30B to 33B, wherein the network information includes information representing at least one of a network congestion notification, an interference level, a measured UE performance metric, a measured performance metric of the cellular communication network, a latency metric, a data throughput metric, a UE perceived throughput metric, a QoS reliability metric, a packet loss rate, a QoS flow delay metric.

In example 35B, the subject matter of any one of examples 30B to 34B, wherein the input data includes time-series data including radio access network measurements of the cellular communication network; and wherein the trained generative model is configured to generate the output data with a conditioning that is based on a scheduling configuration or a network feature associated with the cellular communication network.

In example 36B, the subject matter of example 35B, wherein the trained generative model is further configured to receive a conditioning input data representative of the at least one of the scheduling configuration or the network feature; and wherein the instructions further cause the processor to determine the conditioning input data to condition the trained generative network.

In example 37B, the subject matter of example 36B, wherein the instructions further cause the processor to determine the network feature including at least one of an interference level time frequency pattern, a frequency reuse pattern of a neighboring cell, an inter-cell interference coordination pattern of a neighboring cell, or a feature based on at least one of the frequency reuse patter or the inter-cell interference coordination pattern; and wherein the neighboring cell is a cell within a proximity of a cell served by the network access node.

In example 38B, the subject matter of example 36B or example 37B, wherein the instructions further cause the processor to determine the output data for one or more UEs of the plurality of UEs; and wherein the instructions further cause the processor to determine the scheduling configuration including at least one of a number of resource blocks to be allocated to the one or more UEs, a scheduling metric for the one or more UEs, a proportion fair (PF) metric for the one or more UEs.

In example 39B, the subject matter of any one of examples 36B to 38B, wherein the trained generative model is based on a decoder only transformer architecture configured to operate with a next token prediction mechanism; wherein the trained generative model is configured to predict a radio access network performance parameter for the plurality of UEs based on the input data; and wherein the input data is applied with a positioning encoding before being passed into the decoder only transformer architecture.

In example 40B, the subject matter of example 39B, wherein the instructions further cause the processor to: obtain a determined conditioning input data; and provide the determined conditioning input data to an input of a multi-layer perceptron network configured to calculate scaling and shifting factors for adjusting intermediate outputs within the decoder only transformer architecture, by passing through cross-attention layers inserted between self-attentions layers, or by concatenating the conditioning input data with a received input data to obtain the input data.

In example 41B, the subject matter of any one of examples 30B to 40B, wherein the trained generative model is configured to determine the output data to be generated by calculating scores for a plurality of output candidates and selecting one of the plurality of output candidates based on their respective scores.

In example 42B, the subject matter of any one of examples 30B to 41B, wherein the trained generative model is configured to serve as a reward model for training a scheduler policy agent via reinforcement learning, in which the trained generative model predicts the radio access network performance parameter at a first instance of time and determine a reward for an action taken by the scheduler policy agent for the first instance of time.

In example 43B, the subject matter of any one of examples 30B to 42B, wherein the instructions further cause the processor to schedule a communication resource to communicate with the plurality of UEs based on the output data; and wherein the instructions further cause the processor to encode information indicating the communication resource for a transmission to at least one UE of the plurality of UEs.

While the invention has been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning of the claims are therefore intended to be embraced.

1. An apparatus comprising:
an interface configured to receive first sensor data representative of a monitoring of an environment according to a first modality and second sensor data representative of a monitoring of the environment according to a second modality; and
a processor configured to:
provide the first sensor data to an input of a first trained generative model configured to generate first output data comprising a first extracted feature of the first sensor data in a latent space;
provide the second sensor data to an input of a second trained generative model configured to generate second output data comprising a second extracted feature of the second sensor data in the latent space; and
combine the first output data and the second output data to generate a combined feature.

2. The apparatus of claim 1, wherein the combined feature is representative of a feature of the environment determined based on the first modality and the second modality.

3. The apparatus of claim 1, wherein the apparatus is of a communication device and wherein the processor is further configured to encode the combined feature for a transmission to a further communication device.

4. The apparatus of claim 1, wherein the combined feature is in the latent space and used as an input of a further data fusion network for a hierarchical combining to obtain a further feature.

5. The apparatus of claim 4, wherein the processor is further configured to:
decode feature information representative of a further feature in the latent space, wherein the feature information is received from another communication device and representative of a monitoring of a further environment associated with the another communication device; and
combine the first output data, the second output data, and the further feature to generate the combined feature.

6. The apparatus of claim 4, wherein the processor is further configured to:
decode further sensor data received from a further communication device and representative of a monitoring of an environment associated with the further feature;
provide the further sensor data to an input of a third generative model configured to generate third output data comprising at least one extracted feature of the further sensor data in the latent space; and
combine the first output data, the second output data, and the third output data to generate the combined feature.

7. The apparatus of claim 6, wherein the environment associated with the further communication device and the environment are the same environment; and
wherein the further sensor data represents the environment based on a modality that is different from the first modality and/or the second modality.

8. The apparatus of claim 1, wherein the processor is further configured to:
decode network data received from a further network device and representative of measurements of a network in which the further network device operates;
provide the network data to an input of a further generative model configured to generate further output data comprising at least one extracted feature of the further sensor data in the latent space; and
combine the first output data, the second output data, and the further output data to generate the combined feature.

9. The apparatus of claim 1, wherein the first output data and the second output data comprises respective feature vectors, each feature vector having an equal number of data items; and
wherein the first trained generative model and the second trained generative model are trained together with a common end-to-end loss.

10. The apparatus of claim 1, wherein the first trained generative model is configured to generate the first output data based on first weight parameters of the first trained generative model the second trained generative model is configured to generate the second output data based on second weight parameters of the second trained generative model; and
wherein the first trained generative model and the second generative model are trained such that the first weight parameters of the first trained generative model and the second weight parameters of the second trained generative model comprise shared parameters.

11. The apparatus of claim 1, wherein the processor is further configured to implement a trained fusion network model to generate the combined feature in the latent space.

12. The apparatus of claim 11, wherein the trained fusion network model is trained by configuring a fusion network model to provide its respective output data as an input of a copy of the fusion network model; and
wherein the fusion network model and the copy of the fusion network model are configured to generate their respective output data based on respective weight parameter comprising common weight parameters.

13. The apparatus of claim 1, further comprising:
a first sensor of a first type, the first sensor configured to monitor the environment according to the first modality; and
a second sensor of a second type, the second sensor configured to monitor the environment according to the second modality.

14. An apparatus of a network access node, the apparatus comprising:
a processor configured to:
obtain user equipment (UE)-specific information of a plurality of UEs served by the network access node within a cellular communication network;
determine network information representative of conditions of the cellular communication network; and
provide input data comprising the UE-specific information and the network information to a trained generative model configured to generate output data representative of a scheduling parameter of at least one UE of the plurality of UEs for a radio communication within the cellular communication network.

15. The apparatus of claim 14, wherein the processor is further configured generate a token for the trained generative model based on the UE-specific information and the network information; and
wherein the input data is the token.

16. The apparatus of claim 14, wherein the input data comprises time-series data comprising radio access network measurements of the cellular communication network; and
wherein the trained generative model is configured to generate the output data with a conditioning that is based on a scheduling configuration or a network feature associated with the cellular communication network.

17. The apparatus of claim 16, wherein the trained generative model is further configured to receive conditioning input data representative of the at least one of the scheduling configuration or the network feature; and
wherein the processor is further configured to determine the conditioning input data to condition the trained generative model.

18. The apparatus of claim 17, wherein the processor is further configured to determine the network feature comprising at least one of an interference level time frequency pattern, a frequency reuse pattern of a neighboring cell, an inter-cell interference coordination pattern of a neighboring cell, or a feature based on at least one of the frequency reuse patter or the inter-cell interference coordination pattern; and
wherein the neighboring cell is a cell within a proximity of a cell served by the network access node.

19. The apparatus of claim 14, wherein the trained generative model is configured to determine the output data to be generated by calculating scores for a plurality of output candidates and selecting one of the plurality of output candidates based on their respective scores.

20. The apparatus of claim 14, wherein the processor is further configured to schedule a communication resource to communicate with the plurality of UEs based on the output data; and
wherein the processor is further configured to encode information indicating the communication resource for a transmission to at least one UE of the plurality of UEs.
